(19) United States
(12) Patent Application Publication
(10) Pub. No.: US 2026/0011456 A1
(43) Pub. Date: Jan. 8, 2026

(54) PHYSICS-BASED SYSTEM TO DETECT, FORECAST, AND INFORM AVOIDANCE OF DISRUPTIONS IN FUSION DEVICES

(71) Applicant: Steven Anthony Sabbagh, Warren, NJ (US)

(72) Inventor: Steven Anthony Sabbagh, Warren, NJ (US)

(21) Appl. No.: 19/334,175

(22) Filed: Sep. 19, 2025

Related U.S. Application Data
(63) Continuation of application No. 19/039,986, filed on Jan. 29, 2025.
Application No. 19/039,986 is a continuation of application No. PCT/US2024/019934, filed on Mar. 14, 2024.
(60) Provisional application No. 63/451,996, filed on Mar. 14, 2023.

(51) Int. Cl. G21D 3/00; G05B 19/048; G21B 1/05

(52) U.S. Cl. CPC G21D 3/001; G05B 19/048; G21B 1/057

(57) ABSTRACT

Techniques for detecting, forecasting, and reducing or avoiding disruptions in fusion devices are described. Data corresponding to operation of a fusion device may be received. Based on the data and one or more physics-based models, an occurrence of an event and a criticality level of the event may be determined. Based on criticality level of the event, whether a disruption of plasm will occur may be determined. An indication identifying the event and whether the disruption of plasma in the fusion device will occur may be output to a computing device associated with a user. In some embodiments, based, at least in part, on the criticality level of the first event, a control system associated with the fusion device may be instructed to perform one or more actions.

### GOVERNMENT SUPPORT

This invention was made with Government support under Grant Nos. DE-SC0020415, DE-SC0021311, DE-SC0018623 and DE-SC0016614 awarded by the U.S. Department of Energy. The Government has certain rights in the invention.

### FIELD OF THE INVENTION

The present invention relates to the field of applied physics. More specifically, aspects of the present invention relate to techniques for analyzing the actual or simulated operation of fusion energy confinement devices.

### BACKGROUND

Fusion energy is the energy source that powers the Sun and other stars. The environment in which the fusion energy is produced is called a plasma, a superheated gas sometimes called the 4th state of matter. The study of plasmas is called plasma physics. Plasma confinement device research has yielded devices (e.g., tokamaks) capable of generating energy based on fusion reactions within the confined plasma. The amount of power produced by such devices has increased enormously (exponentially) since the first plasma confinement devices were designed. During operation of such confinement devices, stoppage of the plasma is often referred to as a “disruption.” Disruptions may cause metal fatigue from enormous electromagnetic forces, and undesired metal surface melting due to thermal loading of the interior walls of the device. A physical phenomenon in which electrons speed up to near the speed of light can also happen during a disruption, and these events may cause damage to the device.

### SUMMARY

The present application is directed to a system and computer-implemented method for receiving data corresponding to operation of a fusion device; determining, based on the data and one or more physics-based models, an occurrence of a first event and a criticality level of the first event; determining, based on the criticality level of the first event, whether a disruption of plasma in the fusion device will occur; and outputting to a computing device associated with a user, an indication identifying the first event and whether the disruption of plasma in the fusion device will occur. The data corresponding to operation of a fusion device may correspond to a simulated operation of the fusion device.

The one or more physics-based models may be configured to output a deterministic result of whether the first event occurred. The one or more physics-based models may be configured to apply one or more sets of physics-based rules to output the deterministic result of whether the first event occurred.

The system and computer-implemented method, in determining whether the disruption of plasma in the fusion device will occur, may also determine that disruption of the plasma in the fusion device will occur when the criticality level of the first event satisfies a threshold criticality level.

The system and computer-implemented method may also determine an occurrence of a second event based on the data and the one or more physics-based models; and generate a sequence of events based on the first event and the second event. The second event may occur prior to the first event. The second event occurs after the first event.

The system and computer-implemented method, in generating the sequence of events, may also determine a first time at which the first event occurred; determine a second time at which the second event occurred; and generate the sequence of events when a difference in time between the first time and the second time satisfy a threshold difference.

The system and computer-implemented method may determine whether disruption of the plasma in the fusion device will occur based, at least in part, on the sequence of events.

The system and computer-implemented method, in determining whether the disruption of the plasma in the fusion device will occur, may also determine, based on the sequence of events, a first state and a criticality level of the first state, wherein the first state indicates an operational state of the fusion device or the plasma in the fusion device at a first time; identify a sequence of states, wherein each state in the sequence of states indicates an operational state of the fusion device or the plasma in the fusion device at a corresponding time prior to the first time; and determine whether disruption of the plasma in the fusion device will occur based, at least in part, on the first state and the sequence of states

The system and computer-implemented method, in determining whether disruption of the plasma in the fusion device will occur based, at least in part, on the first state and the sequence of states, may also determine disruption of the plasma in the fusion device will not occur when the first state is same as at least one state within the sequence of states.

The system and computer-implemented method, in determining whether disruption of the plasma in the fusion device will occur based, at least in part, on the first state and the sequence of states, determine whether a criticality level of the first state satisfies a threshold criticality level; and determine disruption of the plasma in the fusion device will occur when the criticality level of the first state satisfies the threshold criticality level.

The system and computer-implemented method, in determining whether disruption of the plasma in the fusion device will occur based, at least in part, on the first state and the sequence of states, may also identify a most recent state in the sequence of states and a corresponding criticality level of the most recent state in the sequence of states when the criticality level of the first state fails to satisfy the threshold criticality level; and determine disruption of the plasma in the fusion device will occur when a difference between the criticality level of the first state and the corresponding criticality level of the most recent state fails to satisfy a threshold criticality level difference.

The present application is also directed to a system and computer-implemented method for receiving during operation of a fusion device, operational data of the fusion device from at least one or more sensors associated with the fusion device; determining, based on the operational data and one or more physics-based models, an occurrence of a first event and a criticality level of the first event; and instructing a control system associated with the fusion device to perform one or more actions to change the operation of the fusion device based, at least in part, on the criticality level of the first event. The operation of the fusion device may be a simulated operation of the fusion device and the control system may be a simulated control system.

The system and computer-implemented method, in instructing a control system associated with the fusion device to perform one or more actions, may also determine whether the criticality level of the first event satisfies a first threshold criticality level; and instruct the control system to perform a controlled shutdown of the fusion device when the criticality level of the first event satisfies the first threshold criticality level.

The system and computer-implemented method may also determine that disruption of the plasma in the fusion device will occur when the criticality level of the first event satisfies a threshold criticality level.

The system and computer-implemented method, in instructing a control system associated with the fusion device to perform one or more actions, may also determine, when the criticality level of the first event fails to satisfy the first threshold criticality level, whether the criticality level of the first event satisfies a second threshold criticality level; and instruct the control system to change an operational parameter of the fusion device to reduce a risk of disruption of plasma in the fusion device when the criticality level of the first event satisfies the second threshold criticality level.

The system and computer-implemented method may also determine an occurrence of a second event based on the data and the one or more physics-based models; and generate a sequence of events based on the first event and the second event. The second event may occur prior to the first event. The second event may occur after to the first event.

The system and computer-implemented method, in generating the sequence of events, may also determine a first time at which the first event occurred; determine a second time at which the second event occurred; and generate the sequence of events when a difference in time between the first time and the second time satisfy a threshold difference.

The system and computer-implemented method may also determine, based, at least in part, on the sequence of events, whether disruption of the plasma in the fusion device will occur.

The system and computer-implemented method, in determining whether disruption of the plasma in the fusion device will occur, may also determine, based on the sequence of events, a first state and a criticality level of the first state, wherein the first state indicates an operational state of the fusion device or the plasma in the fusion device at a first time; identify a sequence of states, wherein each state in the sequence of states indicates an operational state of the fusion device or the plasma in the fusion device at a corresponding time prior to the first time; determine whether disruption of the plasma in the fusion device will occur based, at least in part, on the first state and the sequence of states.

The system and computer-implemented method, in determining whether disruption of the plasma in the fusion device will occur based, at least in part, on the first state and the sequence of states, may also determine disruption of the plasma in the fusion device will not occur when the first state is same as at least one state within the sequence of states.

The system and computer-implemented method, in determining whether disruption of the plasma in the fusion device will occur based, at least in part, on the first state and the sequence of states, may also determine whether a criticality level of the first state satisfies a threshold criticality level; and determine disruption of the plasma in the fusion device will occur when the criticality level of the first state satisfies the threshold criticality level

The system and computer-implemented method, in determining whether disruption of the plasma in the fusion device will occur based, at least in part, on the first state and the sequence of states, may also identify a most recent state in the sequence of states and a corresponding criticality level of the most recent state in the sequence of states when the criticality level of the first state fails to satisfy the threshold criticality level; and determine disruption of the plasma in the fusion device will occur when a difference between the criticality level of the first state and the corresponding criticality level of the most recent state fails to satisfy a threshold criticality level difference.

### BRIEF DESCRIPTION OF DRAWINGS

Aspects of the present invention are illustrated by way of example and not limitation in the figures of the accompanying drawings in which like references indicate similar elements. The drawings provide only a subset of the more detailed capabilities of the system.

FIG. 1 schematically illustrates an example architecture for analyzing operation data of a fusion device and guiding the fusion device, in accordance with some embodiments of the present disclosure.

FIG. 2 illustrates an example block diagram of analysis component, in accordance with some embodiments of the present disclosure.

FIG. 3 illustrates an example graphical user interface (GUI) displaying fusion device data and analysis data, in accordance with some embodiments of the present disclosure.

FIGS. 4A-4B illustrate example GUIs for displaying data based on analysis performed by an analysis component, in accordance with some embodiments of the present disclosure.

FIG. 5 illustrates an example list of events, event types, and some contents of corresponding physics event modules, in accordance with some embodiments of the present disclosure.

FIG. 6 illustrates a list of example events, in accordance with some embodiments of the present disclosure.

FIG. 7 shows an example graphical representation of time rate of change of the product of the moment of inertia and the toroidal rotation frequency of a plasma instability, in accordance with some embodiments of the present disclosure.

FIG. 8 schematically illustrates an example architecture of a real-time analysis of operation data of a fusion device and guiding the fusion device, in accordance with some embodiments of the present disclosure.

FIGS. 9A-9C illustrate example data structures for storing a sequence of events and/or representing data of the sequence of events, in accordance with some embodiments of the present disclosure.

FIG. 10 illustrates an example grouping of and reduction of variables, in accordance with some embodiments of the present disclosure.

FIG. 11 illustrates an example evolution of states of the plasma over time in accordance with some embodiments of the present disclosure.

FIG. 12 illustrates an example data structure to represent various plasma states, in accordance with some embodiments of the present disclosure.

FIG. 13 illustrates an example data structure for representing states of the plasma, in accordance with some embodiments of the present disclosure.

FIG. 14 illustrates an example evaluation of an event chain, in accordance with some embodiments of the present disclosure.

FIG. 15 illustrates a flow diagram showing example operations by a system in accordance with some embodiments of the present disclosure.

FIG. 16 illustrates a flow diagram showing example operations by a system in accordance with some embodiments of the present disclosure.

FIG. 17 schematically illustrates an example computing architecture on which some embodiments of the present disclosure may be implemented.

### DETAILED DESCRIPTION

Fusion devices may be located in various types of facilities including, but not limited to, experimental/research facilities (e.g., a laboratory, research centers, and the like), energy generation facilities (e.g., a power plant, and the like), and other similar facilities. Fusion devices generate and/or produce fusion energy in a confined plasma, which is a superheated gas.

The next-step evolution of fusion devices is to design devices capable of generating electricity for the power grid. That next step may require systems that monitor, detect, forecast, and attempt to avoid events that can happen in the fusion plasma that will stop its operation. For these next-step devices, and even some that are recently built, such a warning system may be needed to avoid device shutdown. During operation of a fusion device, a physical process referred to as a “plasma disruption” (also referred to herein more simply as a “disruption”) may occur. Ideally, events that lead to a plasma disruption could be detected and corrective action taken prior to the disruption occurring. However, accurately determining and/or forecasting whether a plasma disruption will occur is challenging due to the complexity of fusion devices. For example, computer-implemented models of fusion devices may include thousands of state variables and model parameters to describe the operation of the fusion device. The number of variables may increase to many thousands or even tens of thousands when, for example, general machine learning models are used to analyze the complex system in an effort to detect disruptions. In its simplest form, accurately determining and/or forecasting whether a plasma disruption will occur, may be approached as a binary classification problem, with only two possible outcomes that need to be classified for the plasma-non-disrupted, or disrupted. The number of possible states of a dynamical system is n_{c}ⁿsv where n_{c} is the number of classes in the classification, and nsv is the number of state variables. Considering only 100 state variables (e.g. diagnostic data input) for such a system (quite an insufficient number-thousands would likely be needed to model a real system), the number of possible states would be 2¹⁰⁰˜10³⁰ states. Furthermore, in a realistic application to a fusion device, at least 4 classes of the states, not just 2 (binary classification), may be desired. In that case, the number of possible states corresponding to a system with only 100 variables (below critical) is 4¹⁰⁰˜1.6×10⁶⁰ states. Providing a solution based on such an astronomical number of possible states, and without being given a set of rules to determine the state outcome, may be well outside the capabilities of present day exascale supercomputers, which by definition produce ˜10¹⁸ floating point operations per second. Additionally, even if a brute force method is attempted to determine and/or forecast disruption in fusion devices, such an approach may fail to yield the physical understanding required to know what steps to take to improve device operation in unexplored plasma states and/or to facilitate the design of future devices that may be less susceptible to disruptions.

Various aspects of the description herein relate to methods and systems for providing guidance to and understanding of operation or operational runs of a fusion device. In some embodiments, the methods and systems described herein may provide guidance to and understanding of underlying issues preventing continuous operation (e.g., operation in which a disruption does not occur) of the fusion device. In some embodiments, one more systems described herein may be configured to communicatively couple and/or interface with the fusion device to provide feedback that the fusion device may use to mitigate the risk of damage due to disruptions occurring. For example, the one or more systems may send indications and/or instructions to the fusion device or a control system of the fusion device to reduce the risk of plasma disruption and/or continue the plasma operation without occurrence of plasma disruption. Continuous operation of plasma results in the most efficient production of fusion energy. Therefore, guidance providing an understanding of underlying issues of the fusion device that lead to disruptions and/or allowing for continuous operation of the fusion device may significantly improve the ability of a fusion device to efficiently produce fusion energy. Furthermore, the occurrence of plasma disruption in fusion devices that were recently constructed or are currently being constructed can lead to significant damage of the fusion device, which may significantly increase cost due to device repairs and ramifications of device downtime. Therefore, guidance to reduce or avoid plasma disruption based on one or more of the techniques described herein may reduce the possibility of damage to a fusion device. Accordingly, the various techniques, methods, and/or systems described herein may, among other things, improve efficiency of fusion energy production, reduce damage to fusion devices, and/or improve the lifespan of fusion devices.

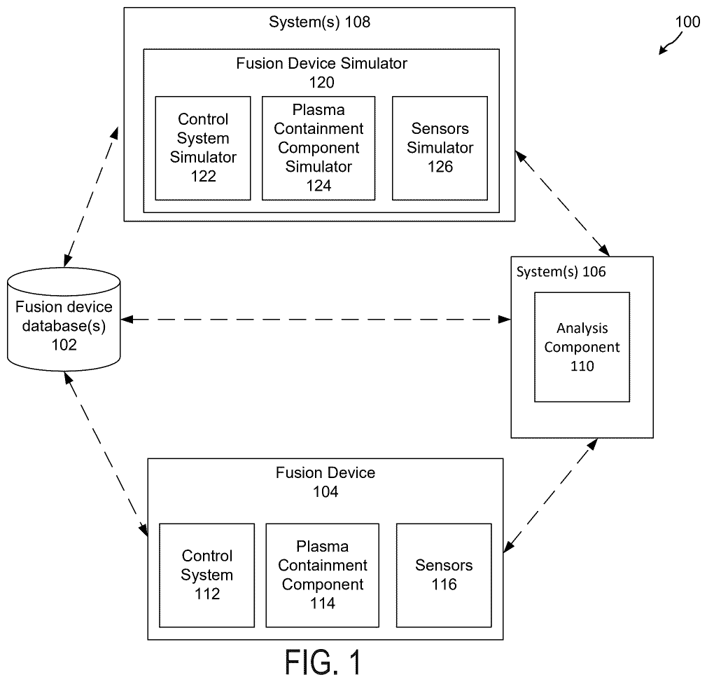

FIG. 1 illustrates a system 100 in accordance with some embodiments of the present disclosure. System 100 includes one or more fusion device databases 102, a fusion device 104,system 106, and system 108. The one or more fusion device databases 102 may be associated and/or communicatively coupled to multiple fusion devices. The one or more fusion device databases 102 may be configured to store operation data from the multiple fusion devices. In some embodiments, a fusion device database 102 may located in a different location from another fusion device database 102. In some embodiments, some of the one or more fusion device databases 102 may be located in different locations from other fusion device databases 102. The one or more fusion device databases 102 may be configured to store a large amount of data. For example, the one or more fusion device databases 102 may store operation data of various fusion devices over a large periods of time, such as 10 years, full lifetimes of the fusion devices, etc. Each of system 106 and system 108 may include one or more computing devices. Fusion device 104 may include a control system 112, a plasma containment component 114, and a plurality of sensors 116. The fusion device 104 may be configured to confine a plasma in the plasma containment component 114 during operation of the fusion device 104. As described herein, an operation of a fusion device (e.g., fusion device 104) may include operation of plasma in the fusion device and/or while the plasma is in operation. In some embodiments, the fusion device 104 may be configured to confine the plasma within the plasma containment component 114 using magnetic field(s). In some embodiments, the fusion device 104 may be configured to confine the plasma in the shape of a torus. Examples of the fusion device 104 may include, but are not limited to, tokamak machines. The fusion device 104 may be configured to, but is not limited to, generate fusion energy, and the fusion device may be located in various types of facilities, including but not limited to, experimental/research facilities (e.g., a laboratory, research centers, and the like), energy generation facilities (e.g., a power plant, and the like), and other similar facilities.

The one or more control systems 112 of the fusion device 104 may be configured to control various aspects of operating the fusion device 104. Examples of controlling such aspects may include, but are not limited to, initiation of an operation of the fusion device 104, modifying one or more operational parameters of the fusion device 104, or shutting down the operation of the fusion device 104. As described in more detail below, system 100 may include an analysis component 110 configured to process sensor data from the plurality of sensors 116, and the one or more control systems 112 may be configured to receive instructions (e.g., via messages, alerts, and the like) from the analysis component 110 and modify the one or more operational parameters of the fusion device 104, shut down the operation of the fusion device 104, and/or initiate the operation of the fusion device 104. Additional details of some examples of operational parameters are described below.

The sensors 116 may be configured to monitor various operational parameters of the fusion device 104. In some embodiments, the control system(s) 112 may be configured to receive data from the sensors 116, and the control system(s) 112 may be configured to modify operational parameters based on the received data. In some embodiments, the fusion device 104 may be communicatively coupled to one or more fusion device databases 102 configured to store various data (e.g., diagnostic data) captured during the operation of the fusion device 104. In some embodiments, fusion device 104 may be communicatively coupled to system 106, which may be configured to process and/or analyze data from the sensors 116. For instance, fusion device 104 may be configured to transmit data from the operation of the fusion device 104 or the operation of the plasma to the analysis component 110 of the system 106.

In some embodiments, system 100 includes system 108. System 108 may include a fusion device simulator 120 (also referred to herein as “simulator 120”) configured to simulate operation of a fusion device (e.g., fusion device 104) using one or more simulation models. The simulator 120 may include a control system simulator 122, plasma containment simulator 124, and sensors simulator 126. The control system simulator 122 may include one or more models that represent operations of a control system of a fusion device such as control system 112. The plasma containment component simulator 124 may include one or more models that represent operations of a plasma containment component of a fusion device such as plasma containment component 114. The sensors simulator 126 may include one or more models that represent operations of one or more sensors of a fusion device, such as sensors 116.

As shown in FIG. 1, system 108 may be communicatively coupled to the fusion device database(s) 102 and/or may be communicatively coupled to system 106. The simulator 120 may be configured to operate in a simulated real-time mode and a simulated offline mode. In the simulated offline mode, the simulator 120 may be configured to store data corresponding to the simulated operations of the fusion device simulator 120 in the fusion device database(s) 102. In the simulated real-time mode, the simulator 120 may be configured to transmit data corresponding to a simulated operation of the simulator 120 to system 106 during performance of a simulation and data received from system 106 may be used by simulator 120 to adjust one or more parameters of the simulation.

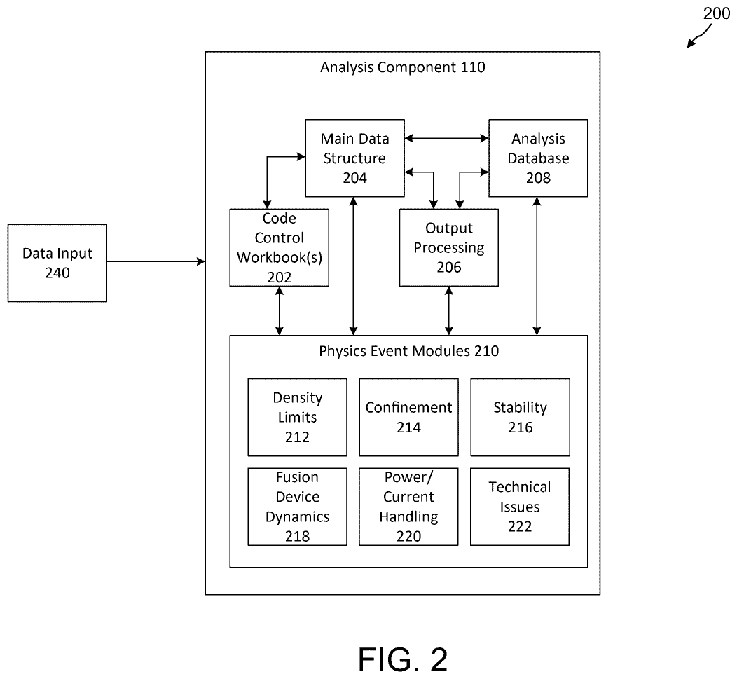

System 106 includes analysis component 110 configured to process incoming data regarding operation of a fusion system (or a simulated fusion system) to determine and/or forecast a disruption. In some embodiments, analysis component 110 may be configured to operate in various modes including, but not limited to, an offline mode, a real-time mode, and/or a simulated offline or real-time mode. In the offline mode, the analysis component 110 may be configured to receive data corresponding to operations of the fusion device 104 or the simulator 120 from fusion device database(s) 102 which, as described herein, may include data corresponding to previous operations of a fusion device, previous simulations of a fusion device, or simulations of a design of a future device. In the offline mode, the analysis component 110 may be configured to analyze the received data to determine occurrence or identifying existence of various events, criticality/warning levels of the events, whether a disruption of plasma occurred, identify physics-based reasons for one or more of the events or their corresponding criticality/warning levels, and other such analysis of the corresponding operation of the fusion device 104 or the simulator 120. Additional details of such analysis are described below with reference to FIGS. 2-16.

In a real-time mode and/or a simulated real-time mode, the analysis component 110 may be configured to receive data corresponding to operation of the fusion device 104 or the simulator 120 during the operation the fusion device 104 or during performance of a simulation by simulator 120. In the real-time mode and/or the simulated real-time mode, based on the analysis of the received data, the analysis component 110 may be configured to transmit instructions to the control system 112 or the control system simulator 122, which may then be used by the corresponding control system to perform one or more actions to change the operation of the fusion device 104 or the simulator 120. The one or more actions may reduce the risk of disruption of plasma in the fusion device 104 or disruption of plasma in the simulation being performed by simulator 120. Examples of the one or more actions that may be performed by the control system may include, but are not limited to, changing one or more operational parameters of the fusion device 104 or the simulator 120, performing a controlled shutdown of the fusion device 104 or the simulator 120, and the like. Additional details of such analysis are described below with reference to FIGS. 2-16.

The analysis component 110 may be fully automated. For example, the analysis component 110 may be configured to automatically process the received fusion device operation data using the various techniques and/or methods described herein. The analysis component 110 may be configured to automatically output the analysis to a computing device of a user (e.g., a user of the fusion device, a researcher of the fusion device, and the like). The analysis component 110 may be configured to automatically instruct a control system of a fusion device (e.g., fusion device 104, simulator 120) to change operations or automatically output the analysis to a computing device of a user. Such automation may be highly advantageous in real-time applications as it may prevent delays and errors that may result from human intervention. Such automation may also be highly advantageous in offline fusion device operation data analysis as it may prevent human bias from affecting the analysis and may prevent human errors in analyzing the data.

The various techniques and/or methods described herein allow for the analysis component 110 to determine, predict, forecast, and/or output data indicating occurrence and/or existence of various events such as plasma disruption event and other events described herein well before the events occur so that there is sufficient time to avoid or mitigate risk of plasma disruption. The analysis component 110 may be configured to process received fusion device operation data and be configured to determine, predict, and/or forecast occurrence and/or existence of various events sufficiently early or well before such events occur. The analysis component 110 may be configured to automatically send data indicating predictions, forecasts, corresponding warnings of the events to control systems of fusion devices sufficiently early or well before such events occur to allow the control systems of fusion devices to successfully avoid or mitigate risk to the fusion device operation. The analysis component 110 may be configured to instruct control systems of fusion devices sufficiently early or well before such events occur to perform actions to avoid or mitigate any risk to the fusion device operation.

The analysis component 110 may be configured to analyze the received data corresponding to the operations of the fusion device 104 or the simulator 120 using one or more modules and other components, examples of which are shown in FIG. 2. While FIG. 1 shows system 100 including multiple systems and devices (e.g., one or more fusion device databases 102, a fusion device 104, system 106, fusion device simulator 120, system 108, and analysis component 110), it should be appreciated that some embodiments may include fewer than all of the components shown in FIG. 1. For example, the techniques and/or methods described herein may be performed by a system including only the analysis component 110 and one or more fusion device databases (e.g., fusion device databases 102), or a system including only the analysis component 110 and a fusion device (e.g., fusion device 104), or a system including only the analysis component 110 and a fusion device simulator (e.g., fusion device simulator 120). Additionally, in some embodiments, the analysis component 110 may be integrated with one or more of the fusion device 104 or the simulator 120 rather than being a separate component.

FIG. 2 illustrates an example block diagram 200 of components within the analysis component 110, in accordance with some embodiments of the present disclosure. The analysis component 110 may include one or more physics event modules 210. Examples of the one or more physics event modules 210 may include, but are not limited to, density limits modules 212, confinement modules 214, stability modules 216, fusion device dynamics modules 218, power/current handling modules 220, fusion device technical issues modules 222, and the like.

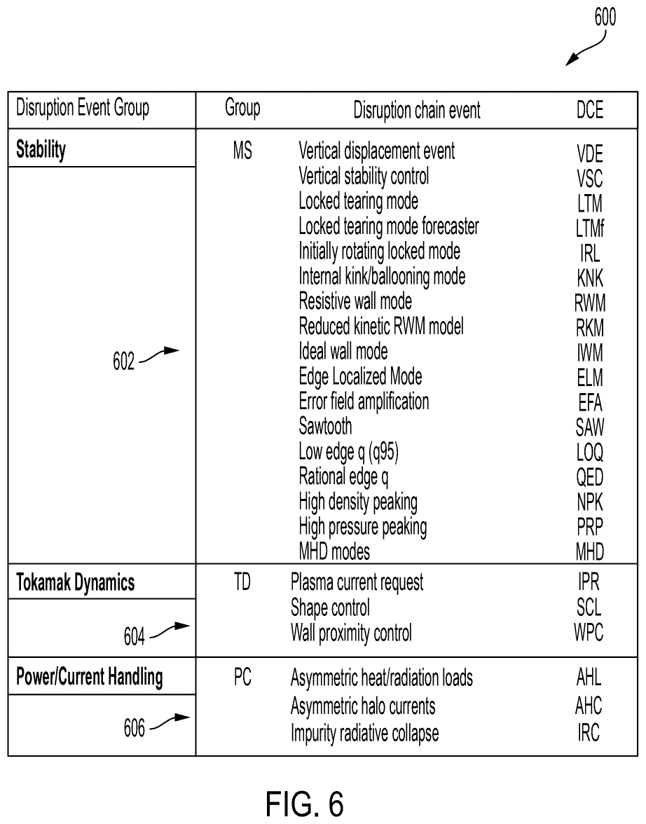

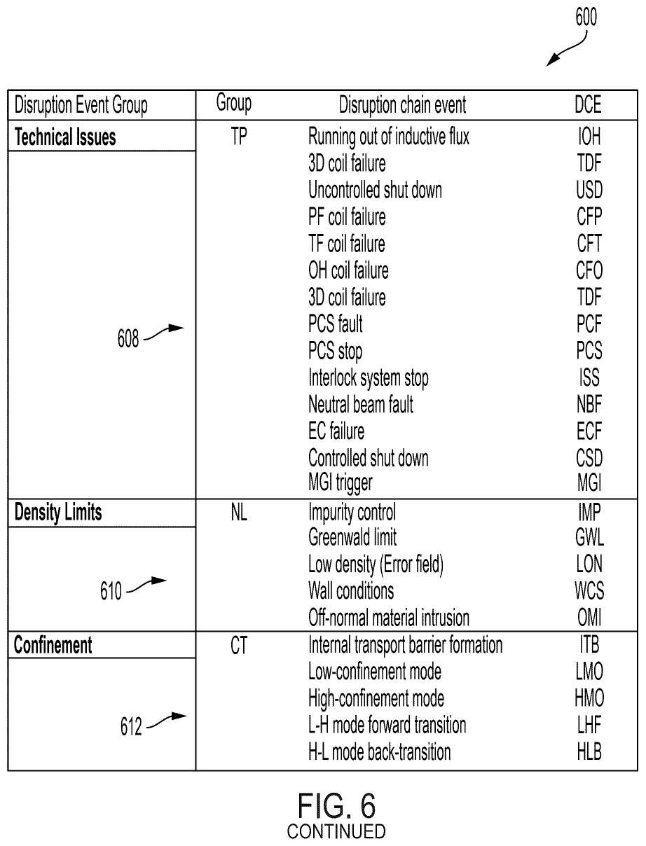

The physics event modules 210 may be configured to determine, based on data input 240 and one or more physics-based equations and/or rules, the occurrence of different events. Particular events or sequences of events may be associated with a corresponding criticality or warning level (referred to herein as a warning level) that may reflect a risk that a disruption will occur. In some embodiments, density limits modules 212 may be configured to, but is not limited to, determine Greenwald limit (GWL), island power balance (IPB), low density (LON), and the like. In some embodiments, confinement module 214 may be configured to, but is not limited to, determine a high confinement mode (H-mode) to low confinement mode (L-mode) back transition (HLB), and the like. In some embodiments, stability module 216 may be configured to, but is not limited to, determine magnetohydrodynamics (MHD) modes, bifurcation (BIF) event, locked tearing mode (LTM), vertical displacement event (VDE), pressure peaking event (PRP), low edge q (LOQ) event, resistive wall mode (RWM) event, reduced kinetic RWM mode (RKM) event, and the like. In some embodiments, the fusion device dynamics module 218 may be configured to, but is not limited to, determine plasma current request (IPR) event, wall proximity control (WPC) event, disruption of plasma (DIS) event, and the like. In some embodiments, the power/current handling module 220 may be configured to, but not limited to, determine asymmetric halo currents (AHC) event, impurity radiative collapse (IRC) event, and the like. In some embodiments, technical issues module 222 may be configured to, but not limited to, determine running out of inductive flux (IOH) event, 3D coil failure (TDF) event, and the like. Additional example events that the different physics event modules 210 may be configured to determine are shown in FIG. 6. Referring now to FIG. 6, there is shown a list 600 of additional example events in accordance with some embodiments of the present disclosure. Different physics event modules 210 (which may include additional physics event modules not shown or described herein) may be configured to determine occurrence or existence of the additional events shown in FIG. 6 and their corresponding warning levels. For example, stability module 216 may be configured to determine occurrence or existence of events in group 602. Similarly, fusion device dynamics event module 218 may be configured to determine occurrence or existence of events in group 604, power/current handling module 220 may be configured to determine occurrence or existence of events in group 606, technical issues module 222 may be configured to determine occurrence or existence of events in group 608, density limits modules 212 may configured to determine occurrence or existence of events in group 601, and confinement event module 214 may be configured to determine occurrence or existence of events in group 610.

Referring back to FIG. 2, the physics event modules 210 may include one or more physics-based models (also referred to herein simply as “physics models”), their attributes, and/or algorithms, methods, computation function(s), and the like. Each of the physics event modules 210 may be configured to determine an occurrence of an event and/or identification of an event and its corresponding warning level based on the one or more physics models, model attributes, algorithms, methods, computational functions, and the like of the physics event module. The one or more physics models and the algorithms may represent physical processes that may occur in the plasma during operation of the plasma or the operation of the fusion device 104. The one or more physics models may be configured to output deterministic (as opposed to probabilistic) results of an event and its corresponding warning level. The one or more physics models may be configured to apply one or more physics-based rules to output the deterministic results. In some embodiments, each of the physics models may be configured to uniquely determine occurrence or identify existence of a physics event.

It should be appreciated that the physics event modules 210 used in accordance with some embodiments are not limited to the modules shown in FIG. 2 or discussed herein. The number of these modules 210 may be expandable as desired. Additionally, it should be appreciated that the various types or number of physics events that the physics events modules 210 are configured to determine the occurrence and/or identify the existence of are not limited to the physics events discussed herein. Rather, the various types or number of physics events determined or identified by the physics event modules 210 may be expanded or increased. In some embodiments, various types or number of physics events may be expanded or increased by configuring one or more physics event modules 210 with one or more physics models and/or algorithms that represent physical processes corresponding to new physics events that happen in the plasma.

In the example architecture of analysis component 110 shown in FIG. 2, the analysis component 110 includes code control workbook(s) 202, main data structure 204, output processing component 206, and analysis database 208. The code control workbook(s) 202 may include various attributes, parameters, configurations, specifications, and the like for the different physics models being used by the physics event modules 210. The analysis component 110 may receive data input 240. Data input 240 may be data provided from fusion device 104 or the simulator 120 during its operation when the analysis component 110 is operating in real-time mode. Data input 240 may be data from database(s) 102, or simulations of device operation, or simulations of the design of future device operation when the analysis component 110 is operating in offline mode. The analysis component 110 may be configured to provide the received data and/or a processed version of the received data to the physics event modules 210. In some embodiments, the code control workbook(s) 202 may include predefined and/or user-defined values to control analysis component 110, physics event model parameters for the physics event modules 210, default values related to these, and the like. In some embodiments, the analysis component 110 may be configured to determine whether values needed for various calculations performed by the physics event modules 210 are received in data input 240. If such values are not received in the data input 240, the analysis component 110 may be configured to provide corresponding predefined and/or user-defined values, default values, and the like from the code control workbook(s) 202 to the physics event modules 210. In some embodiments, the analysis component 110 may be configured to store the received data input 240 and/or the processed version of the received data. In some embodiments, the analysis component 110 may be configured to store the received data input 240 and/or the processed version of the received data in a data structure, or structures, such as the main data structure 204.

One or more of the physics event modules 210 may be configured to interact with one or more other physics event modules 210 and the main data structure 204. For example, output(s) of one or more physics event modules 210 may be provided as an input to another physics event module 210. In some embodiments, each physics event module 210 may be a separate sub-system configured to store information indicating a status of a physics event, such as the warning level of the physics event determined by a physics event module 210.

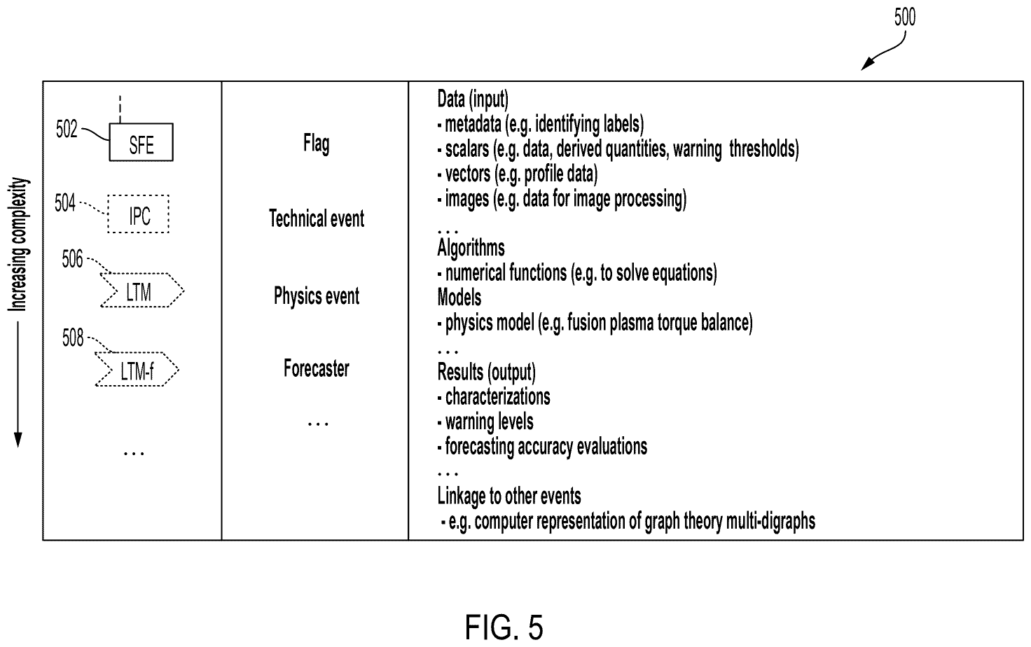

In real-time mode, the analysis component 110 may provide output of the physics event modules 210, such as warning levels of physics events to an event handler (not shown separately). The analysis component 110 may use the event handler to process the output of the physics event modules 210 and determine actions to be taken on the fusion device. Examples of such actions may include, but are not limited to, triggering or instructing control systems (e.g., control system 112 or control system simulator 122) that may change the plasma conditions to reduce risk of or avoid the disruption of plasma, triggering or instructing control systems to initiate a controlled shutdown of the plasma or the fusion device, and/or triggering or instructing control systems to actuate one or more fusion device systems to mitigate the effects of the plasma disruption. The analysis component 110 may be configured to determine these actions based on a physical understanding produced from the states of the physics event modules 210. In the offline mode, the analysis component 110 may be configured to output data corresponding to an analysis of data input 240 to a computing device of a user, such as a user or researcher associated with the fusion device 104 or the simulator 120. Additional details of the analysis that may be performed by analysis component 110 in accordance with some embodiments are described below with reference to FIGS. 5-14.

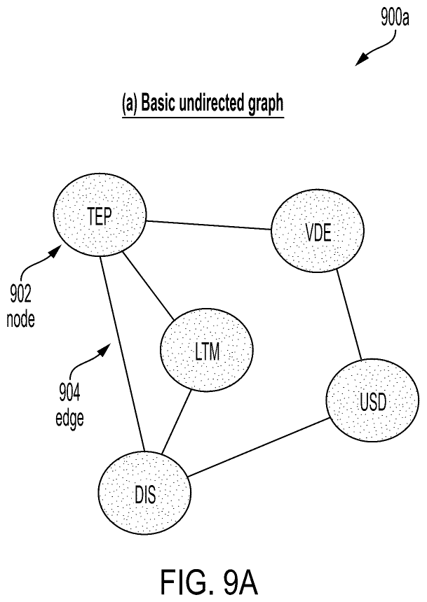

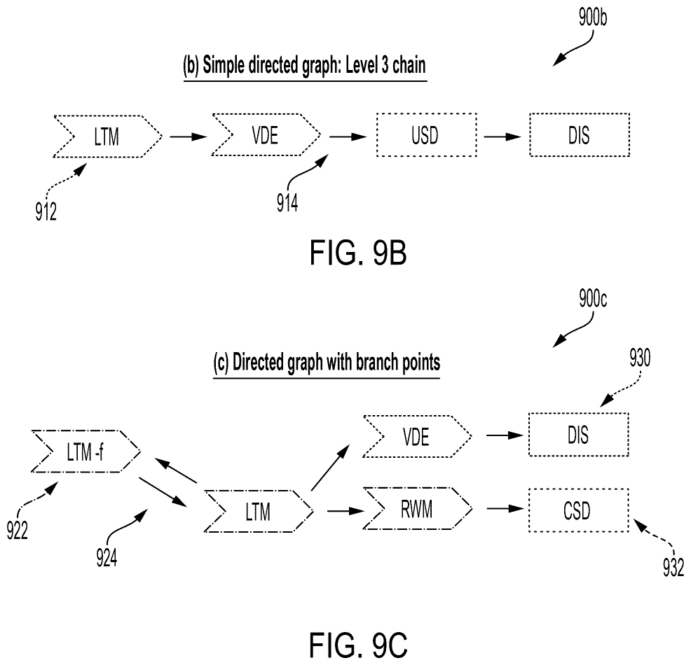

The analysis component 110 may be configured to generate a sequence of events or event chains. The analysis component 110 may be configured to link an event with another event to generate a sequence of events and store the sequence of events along with the links in a data structure, such as a graph data structure. Additional details of generating a sequence of events and storing the sequence of events in a data structure in accordance with some embodiments are described below with reference to FIGS. 9-14.

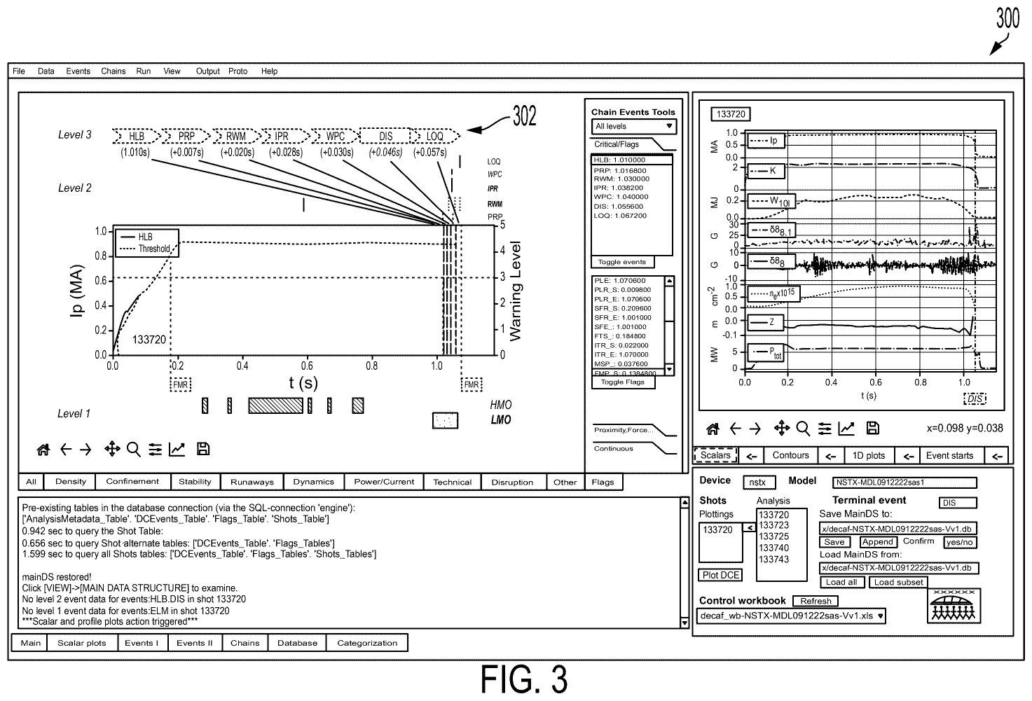

FIG. 3 illustrates an example graphical user interface (GUI) 300, in accordance with some embodiments of the present disclosure. The GUI 300 may be configured to display analysis performed by the analysis component 110. The GUI 300 may display different events determined to occur and/or identified as existing, and their determined warning levels. The GUI 300 may display different event chains or sequences of events (e.g., event chain 302) and other information associated with the events in the event chain, such as time at which the event occurred and the like. In some embodiments, interactions with tabs shown on GUI 300 may access other functionalities, which may be expandable, of the analysis component 110. Additional details of generation of event chains or sequence of events are described below.

In some embodiments, the GUI 300 may indicate a forecast that an event displayed on the GUI 300 will occur at a warning level. In some embodiments, the GUI 300 may indicate and/or identify an event that may lead to occurrence of a disruption of plasma event. In some embodiments, GUI 300 may also display one or more warning levels stating how close the plasma is to result in a disruption event, and other similar information. In some embodiments, one or more of the tabs shown in GUI 300 may be configured to provide additional information on the underlying physics of one or more displayed physics events when selected by a user, information related to the fusion device databases 102 (e.g., connection information and the like), data related to analysis performed by the analysis component 110.

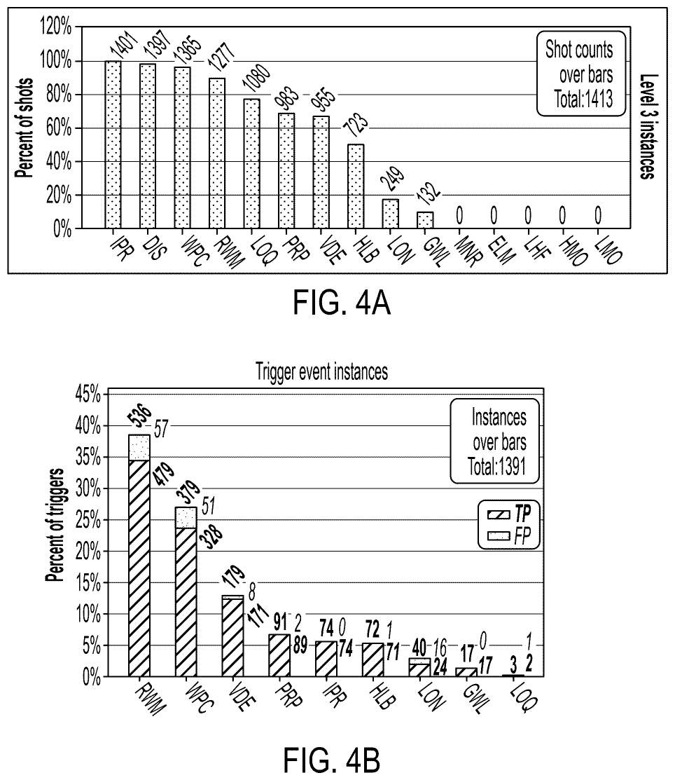

FIGS. 4A and 4B illustrate diagrams of results from two types of analyses performed on the physics event models for a large number of plasmas to determine the occurrence of the corresponding events, in accordance with some embodiments. The results also show when these events appear as “triggers” that start a chain of events that lead to a disruption. In the analysis shown in FIG. 4A, the number of instances that have reached the critical warning level indicating that a disruption will happen (“Level 3 instances”) is shown. In FIG. 4B, the number of events that happen to start the event chain (“triggers”, or “trigger events”) are shown from the analysis. One or more physics models described herein and/or the physics event modules 210may be configured to determine, whether the trigger is accurate, or inaccurate. Additional details of such determination are provided below. These warnings of possible “false” triggers may facilitate automation of the validation processes for which a system described herein may be used, and also to inform the automation of the system on whether to take further actions, or not.

FIG. 5 illustrates an example list of events 500, their types, and some contents of corresponding physics event modules (e.g., physics event modules 210), in accordance with some embodiments of the present disclosure. As described above, analysis component 110 may determine occurrence of, forecast of, and/or identify existence of various types of events, and other analyses based on the operation data of the fusion device 104 and/or the simulator 120. Examples of the various types of events include, but are not limited to, flags, technical events, physics events, and forecaster events. Flag events (e.g., event 502) indicate occurrence of a phenomena, and the analysis component 110 may output an indication identifying a corresponding flag event based on the analysis of the operation data. In some embodiments, flag events indicate occurrence of the phenomena with respect to time (e.g., a time instance, a time duration, a time period, and the like). Technical events (e.g., event 504) may represent a status of various technical aspects of the fusion device 104 or the simulator 120. For example, technical events may indicate whether data acquisition and/or retrieval has successfully completed or not. Some technical events may indicate a status (e.g., operational status) of control hardware, control software, magnetic confinement systems, auxiliary heating systems, power systems, and the like of the fusion device 104 and/or the simulator 120.

Physics events (e.g., event 506) may represent a physics-based process and/or one or more phenomena that occur in the plasma of the fusion device 104 or the simulator 120. As described above, a physics event module 210 may be configured with one or more physics models, algorithms, computation functions, methods, and the like. The physics event module 210 may be configured to use such physics models, algorithms, computation functions, methods, and the like to determine occurrence of and/or identify existence of one or more physics events and their corresponding warning levels at various times (e.g., continuously, periodically, and the like). The physics event module 210 may determine a status of the physics event. The status of the physics event may indicate if/when the physics event occurs, whether a warning level associated with a physics event satisfies (e.g., is greater than or equal t0) a threshold warning level (e.g., a Level 3 warning level), whether the physics event and/or the warning level of the physics event might be considered a significant warning of a disruption of plasma within a threshold amount of time, whether the physics event and/or the warning level indicates that a disruption of the plasma will occur, and the like. Forecaster events (e.g., event 508) may be events that forecast the status of a physical event before it happens. In some embodiments, forecaster events may forecast the status of a physical event before a threshold amount of time. A physics event module 210 may be configured to determine a forecaster event using one or more physics models, semi-empirical models, algorithms, computation functions, methods, and the like, and one or more configurations or rules (e.g., physics based rules, and the like) that indicate limits to fusion device operation. In some embodiments, the analysis component 110 may be configured to forecast whether a plasma disruption will occur based on one or more forecaster events determined by the physics event modules 210.

In some embodiments, warning levels of events determined by a physics event module 210 may be indicated by a numerical value such as a warning level of [0-<1], a warning level of [1-<2], a warning level of [2-<3], a warning level of [3 and above], or some other range of warning levels. In some embodiments, each warning level may be classified into different classifications. For example, a warning level of [0-<1] may be classified as an “Undefined” event, a warning level of [1-<2] may be classified as an “Ordered” event, warning level of [2-<3] may be classified as a “Proximity” event, and warning level of [3 and above] may be classified as a “Critical” event.

In some embodiments, one or more of the physics event modules 210 may be configured to be modular to enable addition, modification, removal, and the like of one or more physics event modules 210 without requiring significant changes to the analysis system 110. In some embodiments, one or more physics event modules 210 may include a complete set of physics models, algorithms, computation functions, methods, and the like needed to compute various functions, values, and the like to determine whether an event occurred and/or exists, a warning level of the event, and other aspects of the event. In some embodiments, in real-time computing environments/applications, one or more physics event modules 210 may be deployed in “edge” computing environments (e.g., edge computing device(s), edge computing system(s)), where the physics event modules 210 may be associated with a fusion device diagnostic that is part of the fusion device facility, but may not be centrally localized on a communication network.

In some embodiments, a complete specification of all parameters associated with a physics event module 210, event chains, physics models, algorithms, etc. may be referred to herein as a “Model.” In some embodiments, the complete specification of the Model may be determined a priori, and any computer controlled variation of this Model may be logged and recorded by the analysis system 110, so that results may be reproduced. In some embodiments, the computer controlled variations may include or exclude variations having to do with results using random number generation, etc.

In some embodiments, the Model may be specified in a code control workbook (e.g., code control workbook 202). In some embodiments, in real-time computing environments/applications, the code control workbook (e.g., code control workbook 202) may be implemented in a distributed computing system (e.g., in an edge computing device/system). In some embodiments, the Model may be specified in alternative ways but deliver analogous functionality.

In some embodiments, a physics event module 210 may be configured to perform various functions autonomously. For example, a physics event module 210 may be configured to determine whether values needed for various calculations performed by the physics event module 210 are received in input data (e.g., data input 240). If such values are not received in the input data, the physics event module 210 may be configured to retrieve corresponding predefined and/or user-defined values, default values, and the like from a code control workbook (e.g., code control workbook 202) and perform the various calculations based in part on the retrieved data from the code control workbook. In some embodiments, various physics event modules 210 may be configured to compute various functions and/or data associated with an event (e.g., warning level of an event) asynchronously (e.g., in parallel). In some embodiments, various physics event modules 210 may be configured to analyze input data using one or more parallel processing techniques and/or in a manner that allows computers of different capabilities (e.g., a laptop, a desktop, a supercomputer cluster) to perform the analysis. In some embodiments, real-time computers may also process various computations of a physics event module 210 in real-time for immediate use during the operation of a fusion device to influence operation of the fusion device.

In some embodiments, the physics event modules 210 may be configured to receive partial data or command input without otherwise compromising other operations the physics event modules 210, analysis component 110, system 106, fusion devices 104, simulator 120, and/or other systems or computing devices of a system (e.g., system 100).

In some embodiments, the physics event modules 210 may be fully automated. For example, the physics event modules 210 may be configured to automatically output analysis of an event (e.g., output warning level of event, whether the event may result in a plasma disruption, and the like), and the analysis component 110 may be configured to automatically instruct a control system of a fusion device (e.g., fusion device 104, simulator 120) to change operations or automatically output the analysis to a computing device of a user. Such automation may be highly advantageous in real-time applications as it may prevent delays and errors that may result from human intervention. Such automation may also be highly advantageous in offline fusion device operation data analysis as it may prevent human bias from affecting the analysis and may prevent human errors in analyzing the data.

Data from different fusion devices may be acquired in different ways and may be processed by scientific professionals (e.g., researchers) in different ways. To enable the physics event modules 210 to process data from any of a variety of different types of fusion devices, the analysis component 110 may be configured in some embodiments to abstract the input data. For example, the analysis component 110 may be configured to abstract the input data to common names used in one or more physics models in different fusion devices. In some embodiments, the analysis component 110 may be configured to use a large set of parameters to match each type of input data to a common name. In some embodiments, physics models of the physics event modules 210 may be abstracted in a similar manner as the input data. The analysis component 110 may be configured to normalize the input data. In some embodiments, the analysis component 110 may be configured to normalize the input data by transforming the input data using one or more mathematical functions, the parameters and the input data. For example, the parameters may be constant values, and the analysis component 110 may multiply the input data with a parameter or a combination of the parameters. In some embodiments, the abstracted and/or normalized input data may be saved in a memory of system 106 or a storage device of or associated with system 106.

In some embodiments, data input from fusion device database 102 may be processed in subsets of data, referred to herein as “chunks.” In some embodiments, the analysis component 110 may transmit the chunks to a parallel processing scheduler (e.g. Simple Linux Utility for Resource Management (SLURM)). In some embodiments, the parallel processing scheduler or the analysis component 110 may be configured to store the processed data in a memory (e.g., in the main data structure 204) of system 106 and/or a storage device of or associated with system 106.

In some embodiments, a set of variables that are common to all physics event modules 210 may be used. An example list of such variables are provided below. It should be appreciated that the below list of variables may be expanded as needed to support various physics models and/or technical models that may improve accuracy in predicting occurrence of events, their corresponding warning levels, and/or analyzing other aspects of the events described herein. As used below, the label “t” denotes an index for an array of times in the plasma evolution.

Default Event variables:

| | |
|---|---|
| name | Event name |
| group | Event group |
| device | Device to which the Event is applied |
| color | A color designator for the Event |
| timePrecision | Period when event occurs (from physics model) |
| times = array(t) | Time base for the Event |
| statusColor = list | Status colors used for the Event evolution |
| DCEPtThreshold | Scalar threshold corresponding to Critical warning |
| totalWarnValue = | Total warning value for the Event |
| array(t) | |
| pctOfPtThreshold = | Warning percentage of threshold levels vs. time |
| array(t) | |
| WarnTests = (name, | List of function names to evaluate warning tests |
| value) | |
| flagOrDCE | States whether the Event is a Flag, or not |
| loadSuccess | Status stating if Event input is complete |
| impactDuration | Impact duration of the Event |
| maxWarningLevel | Maximum warning level for the Event |
| feedbackRequest | Status stating if Event is used in feedback control |
| feedbackStatus | Status of the feedback system used with Event |

An example of an analysis performed by one or more physics event modules 210 is described below. For the purpose of illustrating a clear example, events 504, 506, and 508 of FIG. 5 will be used. As described above, event 504 is a plasma current control status (IPC) event and is a technical event, event 506 is a locked tearing mode (LTM) event and event 508 is a locked tearing mode forecaster (LTM-f) event. Events 506 and 508 are physics events.

LTM is an example of a physics based event in which a physics event module 210 (e.g., stability module 216) may, using input fusion device operation data and various models, algorithms, functions, methods, and the like of the physics event module 210, determine occurrence of and/or identify existence of a LTM physical phenomenon in the fusion device and a warning level associated with LTM. The physics event module 210 may be configured to determine the occurrence of and/or existence of an event and its corresponding warning level as early as possible and with a high accuracy for the warning level. Additional details on determining warning levels are described below. In some embodiments, a physics event module may predict occurrence of the event and/or a warning level of the event at an early time. The prediction may be in concert with the physical characteristics of that event. “Prediction” in this context refers to whether or not the evaluation of the physical event by the physics event module 210 is correct regarding the objective of each warning level to identify a critical state of the plasma evolution, for example, a plasma disruption. In some embodiments, the details, types, and/or number of variables under each category shown below (input, outputs, etc.) may be expanded if, for example, expansion will provide greater accuracy in determining occurrence of events and their corresponding warning levels to predict or forecast a disruption event (DIS), or any other event occurring (e.g. LTM-f reaching the critical warning level 3, which forecasts an LTM event reaching its critical warning level 3). The following may apply to any given plasma evolution, also referred to herein as a “shot” (given an array index (i)).

Example inputs to a physics event module 210 (e.g., stability module 216) to determine occurrence or existence of LTM event:
1. diagnostic data: an array of magnetic pickup loop probe signals mp(k,j) with array indexes k referring to the probe number, and j referring to the time during the plasma evolution.
2. diagnostic data: an array of low frequency magnetic detector signals (e.g. partial saddle coils that are different from the magnetic pickup loops) mplf(k,j) with array indexes k referring to the probe number, and j referring to the time during the plasma evolution.
3. analysis from a collection of diagnostic data (“analysis data”): zero crossing analysis of magnetic pickup probes, which is determined by subtracting the data signals from a pair of probes located on diametrically opposite sides of the device (180 degrees part in toroidal angle) and determining at what times that difference signal crosses zero.
4. analysis data: toroidal mode number, n, decomposition of a Fast Fourier Transform (FFT) analysis of the magnetic pickup probes, creating computer variables giving the amplitude and phase of the various modes
5. analysis data: toroidal mode number decomposition of a Fast Fourier Transform (FFT) analysis of the low frequency magnetic pickup sensors, creating computer variables giving the amplitude and phase of the various modes at frequencies below 2 kHz.
6. analysis data: The computed energy content of the plasma
7. model data: Parameters determining the weighting of the analysis data to produce an Event warning level
8. model data: Parameters setting the thresholds mapping the Event warning level to the system warning Levels (Undefined, Ordered, Proximity, Critical)

Example outputs from the physics event module 210 (e.g., stability module 216)
1. analysis data: data structure containing time evolution of amplitude and phase of all plasma instabilities found (including a range of toroidal mode numbers)
2. analysis data: amplitude of magnetic pickup probe data for the dominant n=1 mode
3. analysis data: phase of magnetic pickup probe data for the dominant n=1 mode
4. analysis data: time evolution of all criteria used to determine the warning level of the event (see real-time specification of LTM Event given later in this document)
5. analysis data: time evolution of the total warning level for the Event
6. status data: time evolution of the applicability of the Event calculation
7. linkages data: links allowing connections to other events based on chronological or other criteria or occurrences over a single plasma evolution
8. linkages data: links allowing connections to other events based on chronological or other criteria or occurrences over an ensemble of plasma evolutions

A physics event module 210 may be configured to use a combination of diagnostic data measured on the fusion device (e.g., fusion device 104 or simulator 120) in many different ways, and different types of analyses of that data, to determine the warning level and other quantitative and qualitative characteristics of the phenomenon or the event. A fusion grade plasma is a high temperature substance, often above 100 million degrees Fahrenheit, and so may require special diagnostic data to measure important plasma parameters, which can be scalars, or vectors of one, two, or three spatial dimensions, or other dimensions used in physics models (e.g. velocity), and time. In the example of the LTM Event, the measurements may be sensed by magnetic probes and are processed in different ways to determine particular perturbations of the magnetic field that confines the plasma. The characteristics of that perturbation will determine the happening of a mode locking. Evaluating the perturbation can be performed in several ways at different levels of sophistication. For example, an array of magnetic pickup loops can be processed using a Fast Fourier Transform (FFT) analysis, and discrete plasma perturbations that are modes of the plasma system can be distinguished based on the FFT analysis. In some embodiments, the physics event modules 210 and/or the analysis component 110 may perform such an analysis and separate the measured modes by their toroidal mode number. An example of measuring the frequency of modes with odd toroidal mode number may be by subtracting the measured time rate of change of the magnetic field using magnetic pickup loops (and low frequency magnetic sensors to measure modes at very low frequency 0-1 kHz) according to the following formula:

$$\frac{d {B}_{o d d - n}}{d t} = \frac{1}{2} ( \frac{d {B}_{s e n s o r 1}}{d t} - \frac{d {B}_{s e n s o r 2}}{d t} )$$

and using the times taBdt-zero (m) at which this variable crosses zero dBodd-n/dt (t)=0 to determine the mode frequency by fodd-n=1/(2 (tdBdt-zero (m+1)-tdBdt-zero (m))). In some embodiments, in non-real-time applications, other advanced techniques as described above may be used to specifically pick out a particular odd-n mode. In real-time applications, discrete modes typically couple together during a mode locking process, and so the detail of their separation may not be critical to detect a dominant mode locking phenomenon that leads to a disruption.

In some embodiments, additional physics characteristics of magnetic mode locking can be considered in LTM due to the flexibility allowed by the physics event module 210 as described above. For example, some fusion devices may have low frequency magnetic sensors that can more accurately measure the mode locking to lower frequencies than magnetic pickup probes. In some embodiments, characteristically different diagnostics (e.g. non-magnetic, such as electron cyclotron emission, or soft X-ray diagnostics) may be used. In some embodiments, a physics event module 210 may analyze evolution of the plasma stored energy, WMHD, as it may be a strong indicator of a mode locking dynamic, and so can also be used as a test condition.

For any combination of available diagnostic data, analysis data, or other information pertinent to the physics of the event being evaluated, a set of tests may be evaluated that determine a warning level for the event. The model that determines the warning level may also be flexible in that any functional form can be chosen. For example, for some modes, a calculation of the mode growth rate might be mapped to warning levels based purely on theory, or in combination with experimental experience retrieved from a database (e.g., fusion device databases 102) to set thresholds of quantitative characteristics of the mode (e.g., by simply comparing to frequency, or amplitude). In some embodiments, a weighted sum of different criteria can be compared to an overall warning level threshold for an Event to determine the warning level. Using LTM as an example, the conditions may be:

$$( i ) {f}_{o d d - n} < fk 1$$

$$( ii ) {W}_{MHD \%} < Δ {W}_{M H D} k 1$$

$$where$$

$${W}_{M H D , \%} = \frac{{W}_{M H D} [ j ] - {W}_{M H D} [ j - 1 ]}{( {t}_{M H D} [ j ] - {t}_{M H D} [ j - 1 ] ) {W}_{M H D} [ j - 1 ]}$$

and fk1 and ΔW_{MHD}K1% are, in general, lists of numbers that map to a lists of weights, W[p], where “p” is an index over the test conditions, which are summed in the time-dependent variable totalWarn Value and compared to the total warning level threshold. As an example:

$$fk 1 = [ 3000 , 10 \; 00 ] maps to W [ p ] = [ 1 , 2 ] ,$$

$$Δ {W}_{MHD} k 1 \% = [ - 7 \text{.5} , - 9. , - 10. 0 ] maps to W [ 2 ] = [ 2 , 3 ] , and$$

$$DCEPtThreshold = 3$$

$$then , for example , if {f}_{odd - n} = 2000 and {W}_{MHD \%} = - 8. at time t ( j )$$

$$totalWarnValue ( t ( j ) ) = SUM ( W [ p ] ) = 1 + 2 = 3$$

$$and$$

$$pctOfPtThreshold ( t ( j ) ) = totalWarnValue ( t ( j ) ) / DCEPtThreshold = 100 \%$$

A result of the above analysis may be that the warning value is 3, indicating that the Critical (Level 3) warning is reached. However, in some embodiments, warning levels may be determined in other ways. For example, Levels 0-3 may be mapped to pctOfPtThreshold values 0%-100% to have a normalized evaluation of the warning levels. Also, the above example shows discrete warning levels for the purpose of illustrating a clear example. In some embodiments, the warnings levels can be made continuous in any number of ways. For example, the warning level may be computed by using a linear interpolation of the fodd-n and WMHD % conditions to their associated lists of weightsW[1] andW[2].

LTM-f is an example of a physics event and a physics event module (e.g., stability module 216) configured to use input fusion device operation data and the various models, algorithms, functions, methods, and the like of the physics event module 210 to determine occurrence of and/or forecast the physical phenomenon LTM. LTM-f is a forecaster event. The forecast determination may be denoted by the warning level with flexibility (e.g., a probability) allowed at the Proximity Level (e.g., Level 2) to best serve the function of database/offline analysis, real-time analysis, or otherwise. In some embodiments, the same quantitative forecasting evaluation for Level 2 may be for both database and real-time analysis to enable direct comparison of the two. In some embodiments, other warning levels may have less flexibility to be able to serve other purposes that the warning levels provide. A forecast at the different warning levels described above may indicate the following:
Level 3: forecasts that the underlying event (here LTM) will reach warning Level 3 and the DIS event will happen.
Level [2-<3]: forecasts that the underlying event (here LTM) and the DIS Event are “close” to occurring (e.g. based on the proximity of the totalWarn Value in reaching the DCEPtThreshold value).
Level [1-<2]: a forecast is possible, but conditions are relatively far from conditions occurring to accurately forecast that the underlying event (here LTM) and DIS Event will occur (e.g., based on the proximity of the totalWarn Value in reaching the DCEPtThreshold value).

Level [0-<1]: a forecast is not possible since the conditions used to evaluate a forecast are not sufficiently well-determined by the measured data, analysis data, or other criteria.

Inputs to a physics event module 210 to determine a forecaster event may be the same or similar as the inputs to the underlying event. For example, inputs to stability module 216 to determine an LTM-f event may be the same as the LTM event described above.

In some embodiments, a physics event module 210 may be configured to solve a mathematical equation, or equations, that represent a physics model or models that allows the forecast to be made at the warning levels described above for a forecaster event. In some embodiments, the output of a physics event module 210 determining occurrence of the forecaster event (e.g., LTM-f event) may be complementary to that of the LTM event. In the case of LTM-f, a physics event module 210 (e.g., stability module 216) may be configured to solve a differential equation below that describes the torque balance between the plasma mode (a drag force) and input momentum sources to the fusion device:

$$\frac{d ( I Ω )}{dt} = {T}_{aux} - {T}_{mode} - \frac{( I Ω )}{{τ}_{2 D}}$$

$$where$$

$${T}_{mode} = \frac{{k}_{2} Ω}{1 + {k}_{3} {Ω}^{2}} .$$

Here, “I” is the plasma moment of inertia, Ω is the mode rotation frequency, Tₐᵤₓ and T_{mode} are the torques imposed on the plasma in the toroidal direction by external sources (e.g., neutral beam injection, that provides heating and momentum) and by the mode, respectively, and [2D is the MHD plasma fluid viscosity. Conventionally, k₂ and k₃ are assumed to be constants, however such an assumption may lead to failure of the model when applied over a wide range of plasma evolutions, and across different fusion devices. Thus, the physics event module 210 may be configured to allow the terms k₂ and k₃ to vary in time, and may associate each element and/or terms with an extension of a physics model.

Depending upon the mode frequency for a given set of parameters (τ_{2D}, k₂, k₃) for the above torque balance models, the torque balance model described above may not have any real equilibrium solutions for the roots d(IΩ)/dt=0 or have multiple solutions. Such physical solutions represent the mode spinning toroidally at a constant frequency and may not lead to disruptions when the frequency is sufficiently large. However, when the model parameters (which may be allowed to be time dependent) are such that no real solutions exist, torque balance cannot be achieved, and the mode frequency can bifurcate and sharply drop to low values—a “mode lock”, or LTM event as described above. Simpler models of T_{mode} may also produce mode locking, such as

$${T}_{mode} = \frac{{k}_{1}}{Ω} .$$

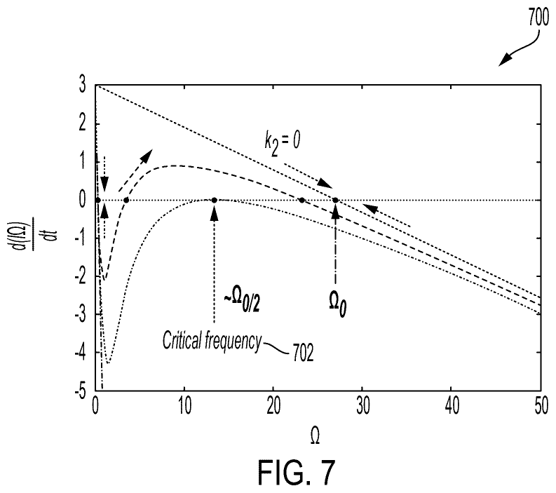

A frequency at which the solutions transition from being real to purely imaginary (in a mathematical sense) is called the “critical frequency,” as shown in FIG. 7, and the critical frequency for the physics model using k₁ may be solved for in terms of the model parameters using the following:

$${Ω}_{inf} = \sqrt{\frac{{k}_{1} {τ}_{2 D}}{I}}$$

In some embodiments, critical frequency, which is time-dependent in the above model, may be added to the outputs of the physics event module 210, along with all of the variables that are computed from the input data, stated as examples of “analysis data.” As described above, for any physics event module 210, additional outputs can be added, typically to yield further information computed from the physical model, or the expansion of such models to make the forecasting capability and/or qualitative agreement between the physics theory and experimental data more accurate.

In some embodiments, the LTM-f event, and other forecaster events, may have one or more time-dependent results that may be used to compare to warning level thresholds. For example, in the case of the LTM-f event, that computed time dependent variable may be Qinf. The evaluation of forecaster solutions can be solved in any way possible: for example, analytically (if possible) or computationally (e.g., by established computational methods). In some embodiments, “artificial intelligence” (AI) approaches may be used to solve one or more of the above-described equations. While AI approaches may be used to solve one or more of the above-described equations, determination of forecaster events may be foundationally or largely physics-based-ranging from empiricism of experimental physics results shown in the data to purely theoretical models.

Determining warning levels for a forecaster event (e.g., LTM-f) may us the same or similar approach as determining the warning level for the underlying/prediction event (LTM). For example, a warning level for LTM-f may be determined as follows:

$$( i ) Ω / {Ω}_{inf} < ltmfl$$

where ltmf1 is, in general, a list of numbers that map to a lists of weights. The same procedure as used for the LTM may then be used for LTM-f, with a different set of weightsW[p] and thresholds that in this case are appropriate for LTM-f, for example:

$$ltmfl = [ 1.30 , 1.15 , 1 \text{.0} ] maps to W [ p ] = [ 1 , 2 , 3 ] ,$$

$$DCEPtThreshold = 3$$

$$then , for example , if Ω / {Ω}_{inf} < 1. at time t ( j )$$

$$totalWarnValue ( t ( j ) ) = SUM ( W [ p ] ) = 3$$

$$and$$

$$pctOfPtThreshold ( t ( j ) ) = totalWarnValue ( t ( j ) ) / DCEPtThreshold = 100 \%$$

Determination of occurrence and/or existence of a technical event, such as IPC, may allow for a more comprehensive analysis of the fusion device operation data, and may provide a better understanding of the fusion device, which may in turn allow for changes to improve prediction and forecasting performance. Determination of occurrence and/or existence of a technical event may be performed without using physics models or input data to such models. For example, technical issues module 222 may be configured to determine occurrence and/or existence of one or more technical events without using physics models or input data to such models.

As described above, one or more outputs of a physics event module 210 may be provided as input to another physics event module 210. In some embodiments, output data of technical issues module 222 related to IPC may be provided as input to a stability module 216 or density limits modules 212, and the analysis performed by the stability module 216 or the density limits modules 212 may be changed based on input data related to IPC.

In some embodiments, the IPC event may provide a status of the control system that provides feedback control for one of the fusion device control systems, such as the plasma current. This event pairs with a related but separate physical event named IPR, and a physics event module 210 configured to analyze data for IPR may determine when the measured plasma current deviates sufficiently far from the time dependent target plasma current as set by the control system. An example of the IPR Event reaching level 3 late in the plasma evolution is shown in the upper left panel of FIG. 3. In FIG. 3, trace 310 shows the measured plasma current, and trace 312, which is overlaid for most of the plasma evolution by trace 310, is the target plasma current. The analysis component 110 may be configured to determine and/or predict that disruption (DIS) will occur when IPR reaches the Critical warning level 3. As shown in FIG. 3, IPR reaching Level 3 is shown to be a true positive result as DIS does appear in the level 3 event chain 302 shown in FIG. 3.

Sometimes the active feedback control system for the plasma current may be deactivated during the plasma evolution. In such a case, determining occurrence of or existence of the IPR event and its warning level may be ill-defined since the system is no longer trying to match the plasma current to a target value. In some embodiments, instead of having IPR be ill-defined, a physics event module 210 (e.g., technical issues module 222) may be configured to monitor all elements of the plasma current active feedback system to determine when the IPR Event should be automatically turned off.

In some embodiments, the inputs to a physics event module 210 for analysis of IPC event may be (1) all data signals or events related to the operation of hardware that support plasma current active feedback and (2) all data signals or events related to the operation of software that support plasma current active feedback. In some embodiments, the outputs of the physics event module 210 analyzing data for an IPC event may include, but are not limited to, (1) analysis data that provides the status of plasma current feedback state computed from the input data and (2) analysis data that provides the status of other variables used by the analysis component 110 and/or other physics event modules 210, including other physics event modules configured to determine plasma current feedback state based on the input data.

In some embodiments, a physics event module 210 (e.g., technical issues module 222) may be configured to evaluate a technical event using functions related to the status of other systems that support the operation of the technical event levels, such as analysis data evaluated by models of any type including, but not restricted to physics models, engineering technical models of relevant systems, AI models determining predicted failure rates of technical systems supporting active feedback, etc.

In some embodiments, warning levels may be determined in a similar manner as the examples shown above with respect to LTM and LTM-f events. The warning levels may not be continuous values, but instead may switch between different levels based on the operational status of the event, and therefore may use a smaller number of values that may be predefined or user defined to indicate different operational status. For example, a warning level of 0 may indicate that status of the event is operational, and 1 may indicate that the status of the event is non-operational.

Technical events such as IPC may provide important supporting information enabling critical physical understanding to the ensemble of events reaching any warning levels. An example of this is the event pair IPR and IPC. If an ensemble of plasma evolutions is analyzed by the analysis component 110, then such an analysis may be fully automated, with no manual pre-filtering of data. Therefore, if some collection of technical failures (e.g., hardware, software, or other technical failure reasons) causes the plasma current active feedback control to fail, then this could generate the IPR Event to issue Critical Level 3 warnings without a DIS Event being present in many cases. Such occurrences may be considered false positive predictions that may produce poor system performance. However, the technical event IPC may clearly separate the fault and restore high prediction accuracy. For example, the physics event module 210 for the IPR event may poll the IPC event, and if the latter shows the technical fault, the IPR warning level may be set to level 0, which indicates that the corresponding event cannot be evaluated. Thus, physics event modules 210 (e.g., technical issues module 222) configured to analyze technical events may greatly improve the predictive and forecasting performance of physics event modules 210 for analyzing physics events (e.g., stability module 216, density limits module 212, and the like).

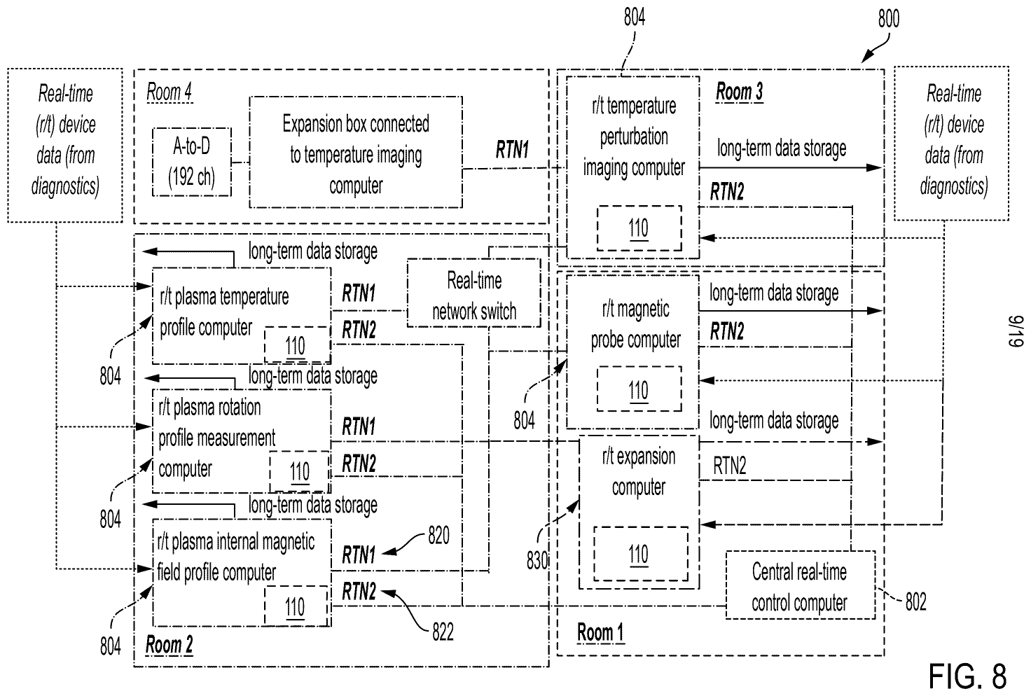

FIG. 8 illustrates an example real-time system 800 in accordance with some embodiments of the present disclosure. System 800 includes a central real-time control computer 802 and one or more real-time computers 804. The one or more real-time computers 804 may include analysis component 110 or elements of it. Data 810 from the fusion device may be collected in real-time from a large variety of diagnostics with different physical principles at the foundation of their operation, some with many channels of data producing one-dimensional or multi-dimensional profiles that measure important plasma quantities.

The real-time computers 804 may be remote from the main real-time control computer 802 and may be associated with one or more diagnostics. The real-time computers 804 may be configured to read the data from the diagnostics in real-time (which may not be usual for such diagnostic systems) and execute the analysis component 110 included in the real-time computers 804 in real-time. In some embodiments, the analysis component 110 may be implemented in a modular manner in the real-time computers 804 and may serve other purposes. The real-time results from the computers 804 may be shared over two real-time networks (RTN) in this example. The RTN1 820 network is a self-contained network that communicatively couple to and/or connect the computers 804 with each other and the RTN2 network 822 may be configured to communicatively couple and/or connect computers 804 to the central real-time control computer 802.

In some embodiments, the analysis component 110 and/or the physics event modules 210 of the analysis component 110 in the different real-time computers 804 may be configured to process data received by the corresponding real-time computer 804 and analyze one or more events described herein, such as determining occurrence and/or existence of an event, warning level of the event, and the like. In some embodiments, analyzing the one or more events in real-time may be similar to the analysis of the events in offline or non-real-time applications. In some embodiments, the analysis component 110 may be configured to be executed on any of the real-time computers 804. In some embodiments, outputs of one or more physics event modules 210 of the different analysis components 110 may be transmitted as inputs to other physics event modules 210 in other real-time computers 804 over the real-time networks RTN1 820 and used by the other physics event modules 210 in analyzing data related to one or more events. As described above, each physics event module 210 may be complete in the modular system shown in FIG. 8. In some embodiments, each of the real-time computers 804 may be considered “edge” computers that may be configured to communicate to the central real-time control computer 802. The system 800 may include r/t expansion computer 830 and its local network connection 832. The r/t expansion computer 830 indicates that the analysis component 110 may be expanded to run on new computers that can be added to the system 800 as needed.

FIGS. 9A-9C illustrate example data structures 900a, 900b, and 900c, respectively, for storing a sequence of events and/or representing data of the sequence of events, in accordance with some embodiments of the present disclosure. FIG. 9A shows an example graph data structure including multiple nodes 902 and multiple edges 904 coupling the nodes 902. A node 902, as shown in FIG. 9A, may store data related to an event in a sequence of events and that node may be linked to other nodes 902 based on the events with which the node event is connected. As shown in FIG. 9A, the edges 904 do not have any implied direction and data structure 900a is an undirected graph.

FIG. 9B shows an example of directed graph (“digraph”) data structure 900b. The directed graph data structure 900b includes multiple nodes 912 and multiple edges 914. The flow of the graph 900b represents the time evolution of the events represented in the graph reaching the Critical level (e.g., level 3). The graph 900b shows the termination of the plasma by the disruption Event (DIS). Using a dynamical systems formalism, the DIS event may be referred to herein as a single point attractor. The event chain or sequence of events represented by graph 900b starts with the LTM event, which may be referred to as the “trigger” event of the event chain. The analysis component 110 may be configured to determine that if any event in the event chain reaches a warning level of level 3, such as the LTM event or the VDE event in 900b, then determine and/or predict that the chain will end in DIS event. The chain ending in a DIS event may be considered a true positive prediction of the plasma disruption.

FIG. 9C shows an example of directed graph data structure 900c. Graph 900c includes multiple nodes 922 and multiple edges 924, and represents another event chain. In graph 900c, as shown in FIG. 9C, the flow does not only represent a chronological set of events whose warning reach the Critical level 3 in a straight line. Additionally graph 900c shows more than one event chain, 930 and 932. Event chain 930 has a single point attractor DIS event and event chain 932 has a single point attractor controlled shutdown event (CSD). In some embodiments, the analysis component 110 may be configured to analyze the event chains 930 and 932 using various physics models, physics rules, functions, methods, etc., as described above, to determine the single point attractors for the event chain 930 to be a DIS event and for the event chain 932 to be a CSD event. In event chain 930, the VDE event reaches a warning level of level 3, and the event chain 930 terminates in the DIS event, indicating a true positive prediction result for the analysis component 110.

Event chain 932 is an example of a Proximity level chain. The trigger event is the locked tearing mode forecaster event, LTM-f, which may forecast that a locked tearing mode (LTM) warning has reached Level 2-which may warn that the plasma is close to DIS, but is not guaranteed to reach DIS. The analysis component 110 may be configured to evaluate the Proximity warning in various ways including, but not limited to, the event warning level specification described above, through qualitative characterization as shown by the event chain 932, and/or by quantitative evaluations by analyzing fusion device operation data from fusion device databases 102 (including simulation analysis data used for device design and other purposes) to determine the number and/or probability of times that any event chain occurs (quantitative numbers not shown in this figure).

The graph 900c shows that the initial LTM-f trigger event leads to an LTM event, which has not reached a Critical level (e.g., Level 3). Then, the flow of the graph shows that the LTM-f reached Level 2 again. This may indicate that the warning of LTM has dropped below Level 2, and a new LTM forecast is being made and indicates a cyclical attractor that then transitions to a resistive wall mode (RWM) Event Proximity warning, and then a CSD that terminates the plasma in a controlled shut down.

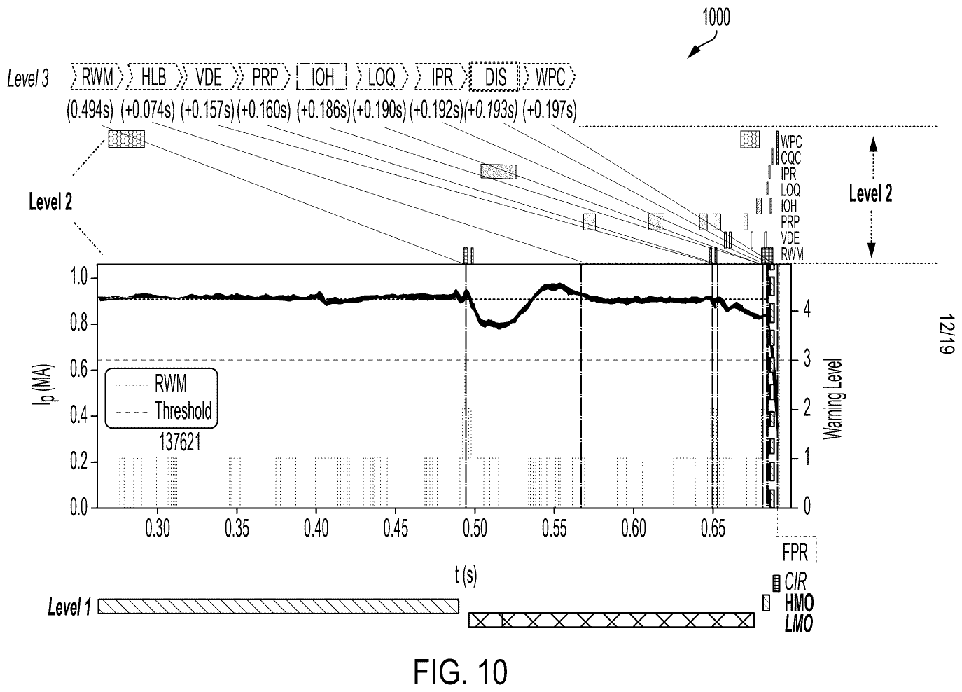

FIG. 10 illustrates an example grouping of and reduction of variables, in accordance with some embodiments of the present disclosure. The analyses component 110 may be configured to group and reduce a number of variables. Grouping and reduction of variables may reduce the state space of the variables to a computationally efficient level. In some embodiments, grouping and reduction of variables may help with automated assessment of evolution of various physical/physics phenomena/principles in the fusion device (e.g., fusion device 104, simulator 120, and the like) based on the evaluation of the events. In some embodiments, grouping and reduction of variables may provide a set of physical principles.

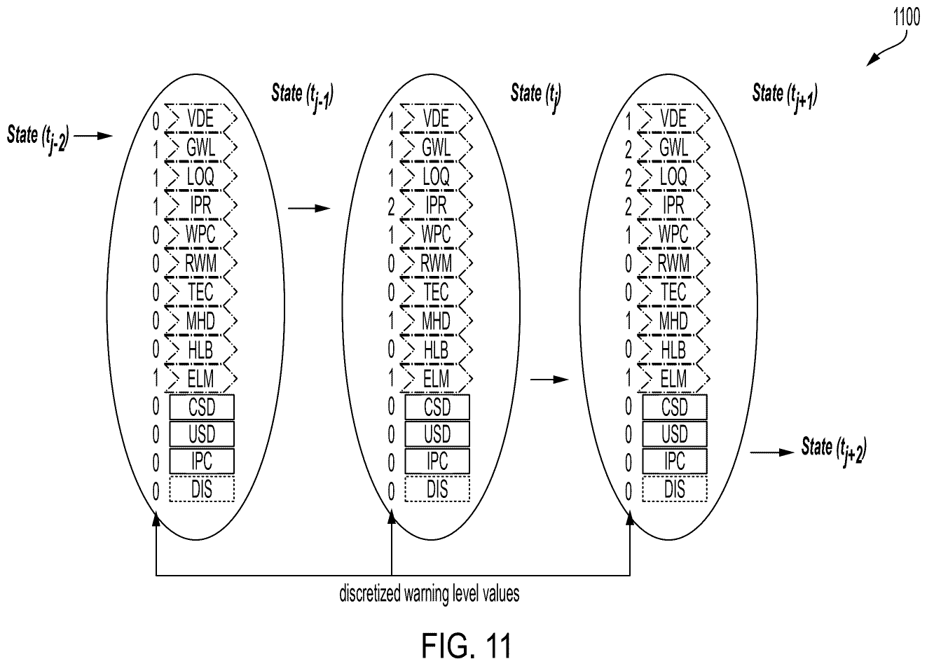

An example of the grouping and reduction of variables is shown in graph 1000 of FIG. 10. Graph 1000 highlights the time at which events are at warning levels 1 and 2 along with level 3. As shown in FIG. 10, only a few of the events are shown at level 1 for clarity. In some embodiments, at each time point, the plasma state may be characterized by a warning level of each event. The collection of events and their warning levels defines a “state” of the plasma or the fusion device for that given collection of events. Recall that the Events comprise diagnostic data, simulation data, computer programmed physics models and the resulting analysis data from them, and other elements that define the Event. Subsets of these data, such as the continuous warning levels being categorized into discrete values, may be used to identify an evolution of the state as shown schematically in another example in FIG. 11.

FIG. 11 illustrates evolution 1100 of states of the plasma over time in accordance with some embodiments of the present disclosure. The analysis component 110 may be configured to determine and/or identify a state of the plasma at a time (e.g., at time tⱼ) based on the warning levels of a collection of events at time tj. In some embodiments, the analysis component 110 may be configured to represent states or collection of events at various times (e.g., times tj-2, tj-1, tj, tj+1, tj+2) as nodes in a graph data structure, examples of which are described in FIGS. 9A-9C. In some embodiments, the analysis component 110 may be configured to connect the nodes with directed edges that connect the nodes advancing in time, referred to herein as state evolution.

In evolution 1100, a state of the plasma changes over time from time tj-2, to tj+2. As time advances, the state changes. The analysis component 110 may be configured to analyze changing of states and/or its collection of events to determine whether a disruption of plasma will occur, instruct a control system of a fusion device to perform one or more actions to reduce risk of plasma disruption, or instruct a control system to perform a controlled shutdown, and the other similar analysis to address the various needs of the fusion devices being analyzed.

In some embodiments, the analysis component 110 may be configured to determine a unique node identification number based on the warning levels of the events of the states. In some embodiments, any attributes of the events may be used in determining a state or the unique node identification number. Over time the states may repeat and/or cluster and the analysis component 110 may be configured to analyze the repetition and/or clustering of states to perform various analysis described herein. In some embodiments, a relatively small number of attributes may be chosen compared to all of the diagnostic, simulation, or analysis data, and the attributes may be chosen such that they best leverage the underlying physics models for scientific understanding and quantitative analysis of the state evolution.

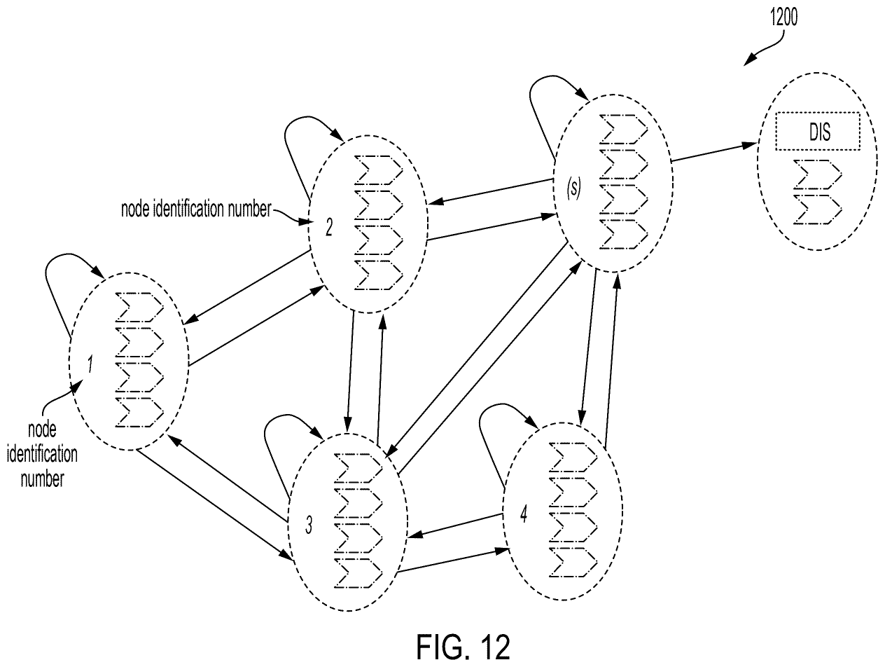

FIG. 12 illustrates an example multi-digraph 1200 representation of plasma states, in accordance with some embodiments. In some embodiments, the analysis component 110 may be configured to construct multi-digraph 1200 from the state evolution graph in FIG. 11. The analysis component 110 may be configured to loop over the number of states in a given plasma evolution from a chosen start time to through a chosen end time tr of that evolution. The analysis component 110 may be configured to uniquely identify the first state, state (t0), by the node identification number as discussed above with reference to FIG. 11. For purposes of this example, the analysis component 110 may be configured to map that unique number to the number “1”, labeling the state with that number. Then, the analysis component 110 may be configured to examine the node identification number for the state at next time point, state (t1). If state (t1)=state (t0), then create an edge that links node 1 to itself. If the states are not equal, create a directed edge from node 1 to state (t₁) and assign that node the unique node identification number 2. If the latter case is constructed, then the analysis component 110 may continue this procedure and examine state (t₂), and, in some embodiments, the analysis component 110 may be configured to continue the process of creating the next node and edge based on the following:
(1) If state (t₂)=state (t₁), create a directed edge that links node 2 to itself, or
(2) If state (t₂)=state (t₀), create a directed edge that links node 2 to node 1
If none of the equality conditions above are met, then:
(3) create a directed edge from node 2 to state (t₂) and assign that node the unique node identification number 3.

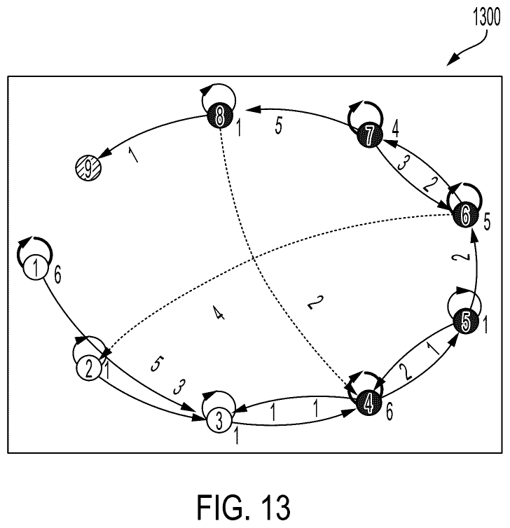

In some embodiments, the analysis component 110 may be configured to continue the above procedure until all state (tⱼ) are linked. In some embodiments, during the above procedure, if the same type of directed edge is generated more than once, the analysis component 110 may be configured to assign a number to that edge to quantify the number of times it was created. An example illustration of such quantification on a graph with nine unique states is shown in FIG. 13.

In some embodiments, during the above described procedure, the analysis component 110 may be configured to exit the loop looking for equality of the next state with existing nodes, and can break once an equality is found. Such configuration may improve performance and efficiency of the analysis component 110. In some embodiments, once the different states of the plasma are represented in the graph structure, it may be highly likely that the state (tⱼ) being examined will equal an existing state, and therefore, the number of nodes in the graph may be far smaller than the original number of states, which may result in a reduction of the number of states to be processed and may allow for a more tractable way in which the plasma state evolution may be analyzed, particularly when compared to a brute force machine learning approach examining all combinations of diagnostic data, and potentially avoid other possible issues such as overfitting.

In some embodiments, graphs similar to the one shown in FIG. 13 may provide significant information allowing analysis of the state evolution and event chains using formalisms from dynamical systems analysis and graph theory, and algorithms appropriate for the problem at hand. Although a plasma in a fusion device is a complex system, the events that describe the system may not be equally distributed. Combinations of events or event chains may typically appear together. Analyzing these event chains may provide key physics understanding and the analysis results can be used to train logic structures, such as neural networks of different types to be used in real-time to sift out problematic combinations of event chains and attempt to break those chains before a disruption is reached and also to find combinations of states, or events, that are not problematic and lead to continuous operation of the fusion device.

The state evolution graph constructed as discussed above and illustrated in FIGS. 12 and 13 may improve efficiency of algorithms used at warning levels 1, 2, and/or other non-critical warning levels. For example, when events are at level 1, there may not be any expected issue that will affect fusion device operation. Based on physics understanding of the event, and database analysis of threshold settings, various event warning thresholds may be set at a threshold that will allow for the plasma to continuously run when it is in this state. Determination or identification of events at level 1 warning may be used to show that an event has occurred, and such information alone or in conjunction with other information of events at level 1 or level 2 may indicate an early cause of concern. For example, FIG. 10 shows the HMO event at level 1, which may be an indicator of a superior confinement state of the plasma and high fusion performance. The analysis component 110 may be configured to determine high fusion performance of the plasma based on the HMO event at level 1.

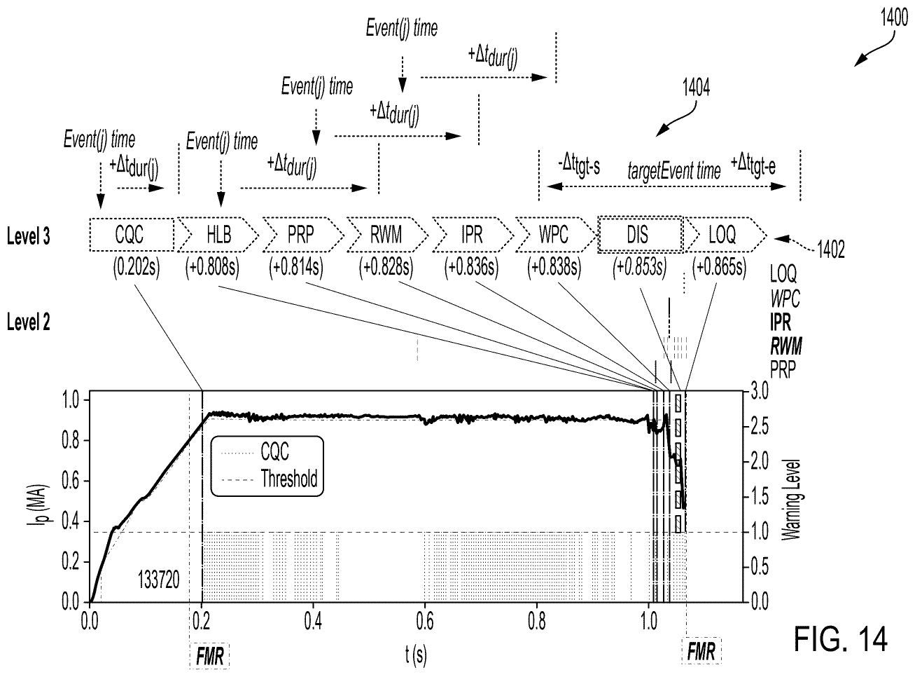

In some embodiments, the analysis component 110 may be configured to analyze one or more events at warning level 2 by polling events at level 1. In some embodiments, the analysis component 110 may be configured to analyze potentially problematic event chains by analyzing the states of the plasma (e.g., states as shown in FIG. 13). In some embodiments, the analysis component 110 may be configured to determine that states that loop back on themselves and are disconnected from the single point attractor state at level 3 that contains DIS, and are states that allow for continuous operation of the fusion device and individual events in such states at finite warning levels, should therefore not be problematic. By examining the evolution of level 2 events shown in FIG. 10, the detail of these states can be seen for a model of analysis component 110 used in this analysis. Examining from early to later times, WPC is shown at level 2, while the plasma is in a high confinement mode of operation (HMO is at level 1). That may be a unique state, and may not be problematic (e.g., no level 3 events in close time proximity defined by the event impact duration). Additional details of event impact duration are provided below with reference to FIG. 14.

Analyzing fusion operation data indicating WPC at warning level 2 and HMO at warning level 1 may produce a unique state that has WPC and HMO that loops back to itself several times. In some embodiments, such analysis results can be captured for future use by informing other computational structures such as a neural network. Aftert˜0.3s, the state is simply HMO at level 1, which again will loop back on itself as time proceeds, with no issues. Similarly, in some embodiments, analyzing other events at level 2 may identify a state evolution where RWM (a global plasma instability) reaches level 2, followed by IPR (plasma current not matching the feedback target value). Based on an analysis of databases (e.g., databases 102) from fusion devices, the analysis component 110 may be configured to the determine that such a combination will often correspond to a level 3 event occurring. An example of such analysis of an event chain shows RWM [symbol] IPR is a problematic chain, and a level 3 event is likely to be associated with this combination. Later states of the plasma produce the following problematic event chains PRP [symbol] WPC [symbol] VDE, and IOH [symbol] RWM [symbol] VDE, both resulting in a disruption plasma event. Furthermore, and as described above, such analysis results may be used to train a neural network for further use including, but not limited to, identifying other problematic event combinations, and the like.

In some embodiments, an event and an event chain structures, as described above, may improve efficiency of automated algorithms of analysis component 110 and/or physics event modules 210 in finding problematic combination of events or event chains. For example, the automated algorithms may:
(1) segregate the states as analyzed by the graph (e.g., graph constructed in FIG. 13) into less and more problematic by their cyclical nature (safer), compared to less cyclical, and/or closer to the single point attractor containing the DIS Event.
(2) reduce the state space dramatically by choosing only the problematic states, then analyze the combinations of Events that occur at Levels 2 and 3 to determine which combinations end in DIS, or other terminations.
(3) compute probabilities that the possible Event Chains found at Level 2 end in DIS, or other terminations.
(4) automate the creation of neural networks or other computational structures and methods that would store these event chain probabilities

In some embodiments, the analysis component 110 may be configured to analyze events and event chains at warning levels 1 and 2 using models and/or algorithms that are not fully deterministic since these warning levels do not produce a DIS event until an event reaches warning level 3. At that point, the analysis is deterministic. For example, the analysis component 110 may be configured to deterministically determine a DIS event will occur if even one event reaches level 3 in an analysis.

As described above, analysis of events at warning level 3 is deterministic. In analyzing level 3 events, the analysis component 110 may be configured to determine whether the individual events reaching level 3 are part of a connected event chain. If the events are not and disjoint, then the analysis component 110 may be configured to determine that a false positive trigger event occurred, and suggest a new trigger event. Having a highly accurate and automated analysis of the level 3 event chains, as described above, may identify at an early time that operation of the fusion device will be disrupted and the analysis component 110 may be configured to provide instruction to a control system of the fusion device to perform one or more of the corrective actions described above.

FIG. 14 illustrates an example evaluation 1400 of an event chain, in accordance with some embodiments of the present disclosure. Event chain 1402 includes one or more events at a warning level 3. The analysis component 110 may be configured analyze event chain 1402. In some embodiments, the analysis component 110 may be configured to analyze the chain 1402 by identifying the earliest event (e.g., based on time at which the event reached warning level 3) in the event chain 1402. In event chain 1402, the earliest event is a CQC event reaching the threshold Critical warning level at t=0.202s. In some embodiments, the time at which an event reached a warning level may be indicated in a GUI as shown in FIG. 14.

The analysis component 110 may be configured to determine the time at which an Event reaches the Critical level, t_{L3}(p), and determine an impact duration of the event, Δt_{dur}(p,t), where “p” is an index for the event in the chain, and “t” is the time during the plasma duration when the analysis is made. In some embodiments, in order for a Critical level 3 event chain to be valid, each event in the chain must “connect” to one of the following events in the chain. The analysis component 110 may be configured to determine a level 3 event chain is valid if:

$${t}_{L 3} ( p ) + Δ {t}_{dur} ( p , j ) > {t}_{L 3} ( p + k )$$

is satisfied at least once, where “k” loops over all Events in the Chain until the DIS event is reached. Here, “j” is an index for the timebase used in the analysis t(j). Also, if

$${t}_{L 3} ( p ) + Δ {t}_{dur} ( p , j ) > {t}_{L 3} ( p + m ) , where m > {k}_{max} ,$$

where kₘₐₓ is the maximum value of k, then the event chain is considered connected through the event with index (p+m).

As described herein, impact duration may indicate a period of time when characteristics of the event in question changes. For example, for a physical event, impact duration may indicate a number of physical growth times of an instability. Similarly, for a plasma transport related event, impact duration may be several characteristic diffusion times associated with that physical phenomenon, such as the energy or momentum confinement time. The analysis component 110 may be configured with one or more algorithms that can evaluate errors in the event chain, and suggest alternate event chains if some events are found to be errant. In chain 1402, the analysis component 110 may determine that the CQC event is not part of the chain 1402 based on impact duration being too small to connect to the next Critical level event. The analysis component 110 may determine that the CQC event cannot be the trigger event and may determine that the HLB event is the trigger event and the remaining events in the chain 1402 form a valid Critical level 3 chain terminated by DIS event.

The analysis component 110 may be configured to determine a target event time indicating when a target event may occur based on input data (e.g., data input 240), data indicating occurrence of one or more events, and/or corresponding warning levels of the one or more events. Target event time (e.g., target event time 1404), as shown in FIG. 14, may span a period of time, rather than indicating one instance of time at which the target event may occur. Some conventional approaches for predicting when an event may occur rely on trying to predict one specific time at which the event will occur. However, such approaches are generally inaccurate and make predictions of when an event may occur too close to the predicted time, which may result in the systems or users being unable to respond to mitigate or avoid the risk of the event occurring.

In some embodiments, target event time for any event at warning level 3 may be defined as:

$${t}_{( E vent period L 3 )} = [ {t}_{( Event L 3 )} - Δ {t}_{tgt - s} , {t}_{( E v ent L 3 )} + Δ {t}_{tgt - e} ] ,$$

where [tₐ, t_{b}] here means the time period between tₐ and t_{b}.

If any of the events in an event chain has:

$${t}_{L 3} ( p ) + Δ {t}_{dur} ( p , j ) > {t}_{( Event L 3 )} - Δ {t}_{tgt - s}$$

then the analysis component 110 may be configured to determine that the events in the event chain are connected to the target event. In FIG. 14, the target event is the DIS event, and the target event time of the DIS event is indicated by the target event time 1404. Based on the above equation, the analysis component 110 may be configured to determine that the events HLB, PRP, RWM, IPR, WPC, as shown in FIG. 14, are connected to DIS event. The analysis component 110 may be configured to similarly determine connections between one or more events or event chain and a target event at any warning level.

In some embodiments, the analysis component 110 may be configured to analyze or evaluate a level 3 chain based on taking into account when one or more events may reach a critical/level 3 warning. In some embodiments, the analysis component 110 may be configured to determine the chronological order of when one or more events (e.g., events in an event chain) reach warning level 3.

In some embodiments, the analysis component 110 may be configured to determine accuracy of its predictions or forecasts. In some embodiments, the analysis component 110 may be configured to use or generate a confusion matrix to determine accuracy of its predictions. In FIG. 14, the DIS event was used as an example target event. However, it should be appreciated that any target event may be used. In some embodiments, the four elements of a confusion matrix may be defined as:
(i) True positive (TP): An event reaches a critical (level 3) warning and a DIS event (or any target event) occurs, and the first event connects to the DIS event time period (or target event time period),
(ii) False positive (FP): An event reaches a critical (level 3) warning and a DIS event (or any target event) does not occur,
(iii) True negative (TN): No event reaches a critical (level 3) warning and a DIS event (or any target event) does not occur, and
(iv) False negative (FN): No event reaches a critical (level 3) warning and a DIS event (or any target event) does occur.

In some embodiments, the analysis component 110 may determine accuracy of its predictions or forecasts by determining the numbers of TP, FP, TN, FN for a forecaster event and its corresponding target event (e.g., LTM-f and LTM). The connections between a trigger event and the target event may be expanded in a similar manner as described above in other embodiments.

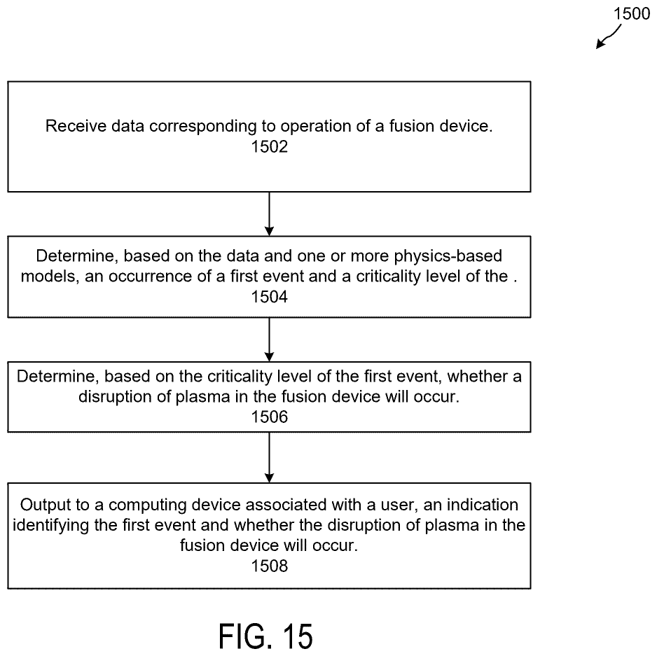

FIG. 15 shows a flowchart illustrating operations of an example method 1500 for determining whether a disruption of plasma will occur, in accordance with some embodiments of the present disclosure. In some embodiments, method 1500 is performed by system 106 (e.g., via analysis component 110) of the system 100.

The method 1500 may include receiving (1502) data corresponding to operation of a fusion device. As described above, the analysis component 110 may be configured to receive the data (e.g., data input 240) from a database (e.g., fusion device database 102). In some embodiments, the operation of the fusion device may be a simulated operation, such as a simulated operation performed by simulator 120, and the data corresponding to the operation may be data corresponding to the simulated operation performed by the simulator 120.

The method 1500 may include determining (1504), based on the data and one or more physics-based models, an occurrence of a first event and a criticality level of the first event. As described above, the analysis component 110 (e.g., via a physics event module 210) may be configured to determine occurrence and/or existence of an event and a criticality level or warning level of the event. In some embodiments, the one or more physics-based models may be configured to output a deterministic result of whether the first event occurred. In some embodiments, the one or more physics-based models may be configured to apply one or more sets of physics-based rules to output the deterministic result of whether the first event occurred.

The method 1500 may include determining (1506), based on the criticality level of the first event, whether a disruption of plasma in the fusion device will occur. As described above, the analysis component 110 may be configured to determine whether the criticality level of the first event satisfies a threshold criticality (e.g., a level 3), and determine whether a disruption will occur based on the criticality level of the first event satisfying the threshold criticality level.

The method 1500 may include outputting (1508) to a computing device associated with a user, an indication identifying the first event and whether the disruption of plasma in the fusion device will occur. As described above, the analysis system 110 may be configured to analyze fusion device operation data from databases (e.g., fusion device databases 102) and output reports, messages, alerts, that indicate whether one or more events that occurred during the fusion device operation led to a disruption of plasma. The analysis results may be written to or stored in long-term computer storage (e.g., analysis database 208) and may reused as needed. In some embodiments, the time to retrieve or restore stored results may typically be substantially more rapid than computing the original result.

In some embodiments, the method 1500 may include determining an occurrence of a second event based on the data and the one or more physics-based models. The method 1500 may include generating a sequence of events based on first event and the second event. In some embodiments, the method 1500 may generate the sequence of events by determining a first time at which the first event occurred, determining a second time at which the second event occurred, and generating the sequence of events when a difference in time between the first time and the second time satisfy a threshold difference. In some embodiments, the method 1500 may determine whether disruption of the plasma in the fusion device will occur based, at least in part, on the sequence of events. In some embodiments, the second event may occur prior to the first event. In some embodiments, the second event occurs after the first event.

In some embodiments, the method 1500 may determine whether the disruption of the plasma in the fusion device will occur by: determining, based on the sequence of events, a first state and a criticality level of the first state, where the first state may indicate an operational state of the fusion device or the plasma in the fusion device at a first time; identifying a sequence of states, where each state in the sequence of states may indicate an operational state of the fusion device or the plasma in the fusion device at a corresponding time prior to the first time; and determining whether disruption of the plasma in the fusion device will occur based, at least in part, on the first state and the sequence of states.

In some embodiments, the method 1500 may determine whether the disruption of the plasma in the fusion device will occur based, at least in part, on the first state and the sequence of states by determining disruption of the plasma in the fusion device will not occur when the first state is same as at least one state within the sequence of states. In some embodiments, the method 1500 may determine whether the disruption of the plasma in the fusion device will occur based, at least in part, on the first state and the sequence of states by determining whether a criticality level of the first state satisfies a threshold criticality level or other criteria, and determining disruption of the plasma in the fusion device will occur when the criticality level of the first state satisfies the threshold criticality level or other criteria.

In some embodiments, the method 1500 may determine whether disruption of the plasma in the fusion device will occur based, at least in part, on the first state and the sequence of states further by identifying a most recent state in the sequence of states and a corresponding criticality level of the most recent state in the sequence of states when the criticality level of the first state fails to satisfy the threshold criticality level, and determining disruption of the plasma in the fusion device will occur when a difference between the criticality level of the first state and the corresponding criticality level of the most recent state fails to satisfy a threshold criticality level difference.

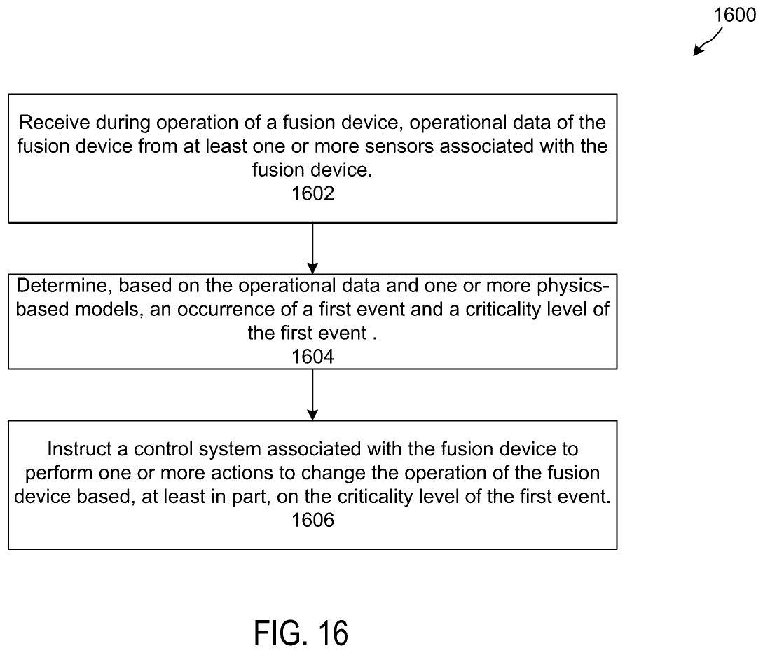

FIG. 16 shows a flowchart illustrating operations of an example method 1600 for instructing a control system of a fusion device, in accordance with some embodiments of the present disclosure. In some embodiments, method 1600 is performed by system 106 (e.g., via analysis component 110) of the system 100.

The method 1600 may include receiving (1602) during operation of a fusion device, operational data of the fusion device from at least one or more sensors associated with the fusion device. As described above, the analysis component 110 may receive data (e.g., data input 240) from a fusion device (e.g., fusion device 104).

The method 1600 may include determining (1604), based on the operational data and one or more physics-based models, an occurrence of a first event and a criticality level of the first event. As described above, the analysis component 110 (e.g., via a physics event module 210) may be configured to determine occurrence and/or existence of an event and a criticality level or warning level of the event. In some embodiments, the one or more physics-based models may be configured to output a deterministic result of whether the first event occurred. In some embodiments, the one or more physics-based models may be configured to apply one or more sets of physics-based rules to output the deterministic result of whether the first event occurred.

The method 1600 may include instructing (1606) a control system associated with the fusion device to perform one or more actions to change the operation of the fusion device based, at least in part, on the criticality level of the first event. As described above, the analysis component 110 may be configured to output instructions to control system (e.g., control system 112 or simulated control system 122) of a fusion device (e.g., fusion device 104 or simulator 120). In some embodiments, the operation of the fusion device may be a simulated operation of the fusion device and the control system may be a simulated control system.

In some embodiments, the method 1600 may instruct a control system associated with the fusion device to perform one or more actions by determining whether the criticality level of the first event satisfies a first threshold criticality level, and instructing the control system to perform a controlled shutdown of the fusion device when the criticality level of the first event satisfies the first threshold criticality level. In some embodiments, the method 1600 may determine that disruption of the plasma in the fusion device will occur when the criticality level of the first event satisfies a threshold criticality level.

In some embodiments, the method 1600 may instruct a control system associated with the fusion device to perform one or more actions by determining, when the criticality level of the first event fails to satisfy the first threshold criticality level, whether the criticality level of the first event satisfies a second threshold criticality level, and instructing the control system to change an operational parameter of the fusion device to reduce a risk of disruption of plasma in the fusion device when the criticality level of the first event satisfies the second threshold criticality level. In some embodiments, the method 1600 may determine an occurrence of a second event based on the data and the one or more physics-based models, and generating a sequence of events based on the first event and the second event. In some embodiments, the second event may occur prior to the first event. In some embodiments, the second event may occur after the first event.

In some embodiments, the method 1600 may generate the sequence of events by determining a first time at which the first event occurred, determining a second time at which the second event occurred, and generating the sequence of events when a difference in time between the first time and the second time satisfy a threshold difference. In some embodiments, the method 1600 may include determining, based, at least in part, on the sequence of events, whether disruption of the plasma in the fusion device will occur.

In some embodiments, the method 1600 may determine whether disruption of the plasma in the fusion device will occur by: determining, based on the sequence of events, a first state and a criticality level of the first state, wherein the first state indicates an operational state of the fusion device or the plasma in the fusion device at a first time; identifying a sequence of states, wherein each state in the sequence of states indicates an operational state of the fusion device or the plasma in the fusion device at a corresponding time prior to the first time; determining whether disruption of the plasma in the fusion device will occur based, at least in part, on the first state and the sequence of states.

In some embodiments, the method 1600 may determine whether disruption of the plasma in the fusion device will occur based, at least in part, on the first state and the sequence of states by determining disruption of the plasma in the fusion device will not occur when the first state is same as at least one state within the sequence of states. In some embodiments, the method 1600 may determine whether disruption of the plasma in the fusion device will occur based, at least in part, on the first state and the sequence of states by determining whether a criticality level of the first state satisfies a threshold criticality level, and determining disruption of the plasma in the fusion device will occur when the criticality level of the first state satisfies the threshold criticality level.

In some embodiments, the method 1600, may determine whether disruption of the plasma in the fusion device will occur based, at least in part, on the first state and the sequence of states by identifying a most recent state in the sequence of states and a corresponding criticality level of the most recent state in the sequence of states when the criticality level of the first state fails to satisfy the threshold criticality level, and determining disruption of the plasma in the fusion device will occur when a difference between the criticality level of the first state and the corresponding criticality level of the most recent state fails to satisfy a threshold criticality level difference.

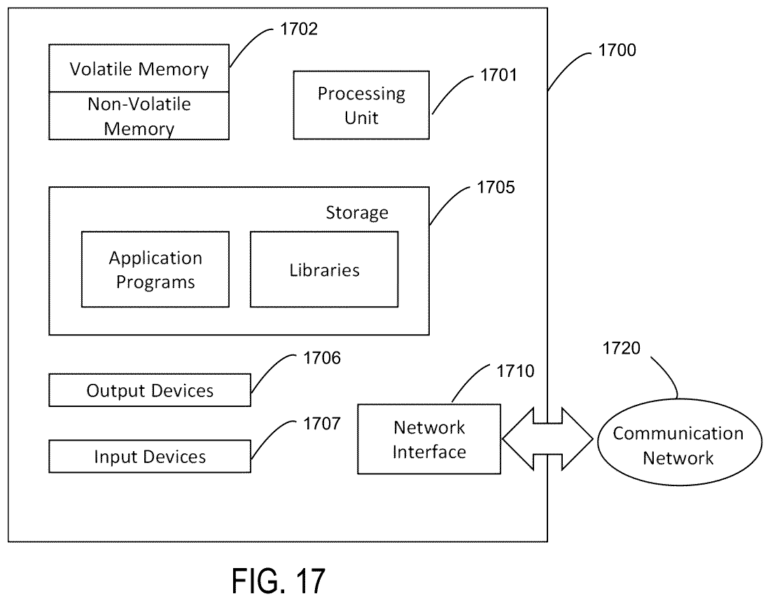

FIG. 17 shows, schematically, an illustrative computer 1700 on which any aspect of the present disclosure may be implemented. In the example of FIG. 12, the computer 1700 includes a processing unit 1701 having one or more computer hardware processors and one or more articles of manufacture comprising at least one non-transitory computer-readable medium (e.g., a memory 1702 that may include, for example, volatile and/or non-volatile memory). The memory 1702 may store one or more instructions to program the processing unit 1701 to perform any of the functionalities described herein. The computer 1700 may also include other types of non-transitory computer-readable media, such as a storage 1705 (e.g., one or more disk drives) in addition to the memory 1702. The storage 1705 may also store one or more application programs and/or resources used by application programs (e.g., software libraries), which may be loaded into the memory 1702. Thus, the memory 1702 and/or the storage 1705 may serve as one or more non-transitory computer-readable media storing instructions for execution by the processing unit 1701.

The computer 1700 may have one or more input devices and/or output devices, such as devices 1706 and 1707 illustrated in FIG. 17. These devices may be used, for instance, to present a user interface. Examples of output devices that may be used to provide a user interface include printers, display screens, and other devices for visual output, speakers and other devices for audible output, braille displays and other devices for haptic output, etc. Examples of input devices that may be used for a user interface include keyboards, pointing devices (e.g., mice, touch pads, and digitizing tablets), microphones, etc. For instance, the input devices 1707 may include a microphone for capturing audio signals, and the output devices 1706 may include a display screen for visually rendering, and/or a speaker for audibly rendering, recognized text.

In the example of FIG. 17, the computer 1700 also includes one or more network interfaces (e.g., a network interface 1710) to enable communication via various networks (e.g., a network 1720). Examples of networks include local area networks (e.g., an enterprise network), wide area networks (e.g., the Internet), etc. Such networks may be based on any suitable technology operating according to any suitable protocol, and may include wireless networks and/or wired networks (e.g., fiber optic networks). In some embodiments, such networks real-time networks configured to enable real-time computer interfacing and/or real-time computing, as shown, for example, in FIG. 8.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing descriptions and drawings are by way of example only.

The above-described embodiments of the present disclosure can be implemented in any of numerous ways. For example, the embodiments may be implemented using hardware, software, or a combination thereof. When implemented in software, the software code may be executed on any suitable processor or collection of processors, whether provided in a single computer, or distributed among multiple computers.

Also, the various methods or processes outlined herein may be coded as software that is executable on one or more processors running any one of a variety of operating systems or platforms. Such software may be written using any of a number of suitable programming languages and/or programming tools, including scripting languages and/or scripting tools. In some instances, such software may be compiled as executable machine language code or intermediate code that is executed on a framework or virtual machine. Additionally, or alternatively, such software may be interpreted.

The techniques described herein may be embodied as a non-transitory computer-readable medium (or multiple such computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer-readable medium) encoded with one or more programs that, when executed on one or more processors, perform methods that implement the various embodiments of the present disclosure described above. The computer-readable medium or media may be portable, such that the program or programs stored thereon may be loaded onto one or more different computers or other processors to implement various aspects of the present disclosure as described above.

The terms “program” or “software” are used herein to refer to any type of computer code or set of computer-executable instructions that may be employed to program one or more processors to implement various aspects of the present disclosure as described above. Moreover, it should be appreciated that according to one aspect of this embodiment, one or more computer programs that, when executed, perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Program modules may include routines, programs, objects, components, data structures, etc. that perform particular tasks or implement particular abstract data types. Functionalities of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields to locations in a computer-readable medium, so that the locations convey how the fields are related. However, any suitable mechanism may be used to relate information in fields of a data structure, including through the use of pointers, tags, and/or other mechanisms that establish how the data elements are related.

Various features and aspects of the present disclosure may be used alone, in any combination of two or more, or in a variety of arrangements not specifically described in the foregoing, and are therefore not limited to the details and arrangement of components set forth in the foregoing description or illustrated in the drawings. For example, aspects described in one embodiment may be combined in any manner with aspects described in other embodiments.

Also, the techniques described herein may be embodied as methods, of which examples have been provided. The acts performed as part of a method may be ordered in any suitable way. Accordingly, embodiments may be constructed in which acts are performed in an order different from illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Also, the phraseology and terminology used herein is for the purpose of description and should not be regarded as limiting. The use of “including,” “comprising,” “having,” “containing,” “involving,” “based on,” “according to,” “encoding,” and variations thereof herein, is meant to encompass the items listed thereafter and equivalents thereof as well as additional items.

An example real-time specification of LTM event is provided below. The below example is a non-limiting example implementation of determining an LTM event and outputting corresponding warnings (e.g., to control systems of fusion devices or simulated control systems of a simulator).

1-57. (canceled)

58. A method comprising:
receiving data corresponding to operation of a fusion device;
determining, based on the data and one or more physics-based models, an occurrence of a collection of events having effects linked in time and an event criticality level associated with each event in the collection of events, wherein the collection of events and the event criticality level associated with each event in the collection of events represents a state of a plasma within the fusion device;
determining, based on the state of the plasma, a warning level, wherein the warning level represents a warning that a disruption of the plasma will occur or is likely to occur; and
outputting to a computing device, an indication identifying the collection of events and the warning level.

59. The method of claim 58, wherein determining, based on the state of the plasma, a warning level comprises:
determining that disruption of the plasma in the fusion device will occur or is likely to occur when the event criticality level of at least one event in the collection of events, satisfies a threshold criticality level.

60. The method of claim 58, further comprising:
determining a chain criticality level associated with a chain of events in the collection of events; and
determining that disruption of the plasma in the fusion device will occur or is likely to occur when the chain criticality level associated with the chain of events, satisfies a threshold criticality level.

61. The method of claim 58, wherein the state of the plasma comprises a first state of the plasma, the method further comprising:
identifying a sequence of states of the plasma, wherein the sequence of states includes the first state of the plasma and one or more additional states of the plasma linked in time to the first state of the plasma, each state of the plasma in the sequence of states of the plasma including a respective collection of events; and
determining a warning level is further based, at least in part, on the sequence of states of the plasma.

62. The method of claim 61, wherein determining a warning level based, at least in part, on the sequence of states of the plasma comprises:
determining a first group of states in the sequence of states, wherein all states in the first group of states have a first warning level;
determining a second group of states in the sequence of states, wherein all states in the second group of states have a second warning level, wherein the second warning level is higher than the first warning level; and
determining that disruption of the plasma in the fusion device will occur or is likely to occur based on the first warning level and the second warning level.

63. The method of claim 62, further comprising:
instructing a control system associated with the fusion device to perform one or more actions to change an operation of the fusion device based, at least in part, on the collection of events associated with at least one state in the second group of states,
wherein the one or more actions are selected to reduce the warning level for the plasma from the second warning level to the first warning level.

64. The method of claim 61, further comprising:
instructing a control system associated with the fusion device to perform one or more first actions to change an operation of the fusion device based, at least in part, on a time evolution of states of the plasma represented in the sequence of states of the plasma,
wherein the one or more first actions are selected to control the fusion device to revert a second state of the plasma to the first state of the plasma, the second state being later in time than the first state in the sequence of states of the plasma.

65. The method of claim 64, further comprising:
instructing the control system to perform one or more second actions to change an operation of the fusion device based, at least in part, on the time evolution of states of the plasma represented in the sequence of states of the plasma,
wherein the one or more second actions are selected to reduce a warning level associated with the first state of the plasma to a lower warning level.

66. The method of claim 58, wherein receiving data corresponding to operation of a fusion device comprises receiving data corresponding to a simulated operation of the fusion device.

67. A system comprising:
at least one processor; and
at least one memory including instructions that, when executed by the at least one processor, cause the system:
receive data corresponding to operation of a fusion device;
determine, based on the data and one or more physics-based models, an occurrence of a collection of events having effects linked in time and an event criticality level associated with each event in the collection of events, wherein the collection of events and the event criticality level associated with each event in the collection of events represents a state of a plasma within the fusion device;
determine, based on the state of the plasma, a warning level, wherein the warning level represents a risk that a disruption of the plasma will occur; and
output to a computing device, an indication identifying the collection of events and the warning level.

68. The system of claim 67, wherein determining, based on the state of the plasma, a warning level comprises:
determining that disruption of the plasma in the fusion device will occur or is likely to occur when the event criticality level of at least one event in the collection of events, satisfies a threshold criticality level.

69. The system of claim 67, wherein the instructions, when executed by the at least one processor, further cause the system to:
determine a chain criticality level associated with a chain of events in the collection of events; and
determine that disruption of the plasma in the fusion device will occur or is likely to occur when the chain criticality level associated with the chain of events, satisfies a threshold criticality level.

70. The system of claim 67, wherein the state of the plasma comprises a first state of the plasma, and the instructions, when executed by the at least one processor, further cause the system to:
identify a sequence of states of the plasma, wherein the sequence of states includes the first state of the plasma and one or more additional states of the plasma linked in time to the first state of the plasma, each state of the plasma in the sequence of states of the plasma including a respective collection of events; and
determine a warning level is further based, at least in part, on the sequence of states of the plasma.

71. The system of claim 70, wherein determining a warning level based, at least in part, on the sequence of states of the plasma comprises:
determining a first group of states in the sequence of states, wherein all states in the first group of states have a first warning level;
determining a second group of states in the sequence of states, wherein all states in the second group of states have a second warning level, wherein the second warning level is higher than the first warning level; and
determining that disruption of the plasma in the fusion device will occur or is likely to occur based on the first warning level and the second warning level.

72. The system of claim 71, wherein the instructions, when executed by the at least one processor, further cause the system to:
instruct a control system associated with the fusion device to perform one or more actions to change an operation of the fusion device based, at least in part, on the collection of events associated with at least one state in the second group of states,
wherein the one or more actions are selected to reduce the warning level for the plasma from the second warning level to the first warning level.

73. The system of claim 72, wherein the instructions, when executed by the at least one processor, further cause the system to:
instruct a control system associated with the fusion device to perform one or more first actions to change an operation of the fusion device based, at least in part, on a time evolution of states of the plasma represented in the sequence of states of the plasma,
wherein the one or more first actions are selected to control the fusion device to revert a second state of the plasma to the first state of the plasma, the second state being later in time than the first state in the sequence of states of the plasma.

74. The system of claim 73, wherein the instructions, when executed by the at least one processor, further cause the system to:
instruct the control system to perform one or more second actions to change an operation of the fusion device based, at least in part, on the time evolution of states of the plasma represented in the sequence of states of the plasma,
wherein the one or more second actions are selected to reduce a warning level associated with the first state of the plasma to a lower warning level.

75. The system of claim 67, wherein receiving data corresponding to operation of a fusion device comprises receiving data corresponding to a simulated operation of the fusion device.

76. A system comprising:
a fusion device including a control system, one or more sensors, and a plasma containment component;
at least one processor; and
at least one memory including instructions that, when executed by the at least one processor, cause the system to:
receive during operation of a fusion device, operational data of the fusion device from at least one or more sensors associated with the fusion device;
determine, based on the operational data and one or more physics-based models, an occurrence of a collection of events having effects linked in time and an event criticality level associated with each event in the collection of events, wherein the collection of events and the event criticality level associated with each event in the collection of events represents a state of a plasma within the plasma containment component;
determine, based on the state of the plasma, a warning level, wherein the warning level represents a risk that a disruption of the plasma will occur or is likely to occur; and
instruct a control system associated with the fusion device to perform one or more actions to change the operation of the fusion device based, at least in part, on the state of the plasma and the warning level,
wherein the one or more actions are selected to reduce the warning level.
